(19) United States
(12) Patent Application Publication
(10) Pub. No.: US 2026/0281340 A1
(43) Pub. Date: Sep. 17, 2026

(54) PARTITION SYMBOL CONTEXT MODELS FOR IMAGE AND VIDEO CODING

(71) Applicant: GOOGLE LLC, Mountain View, CA (US)

(72) Inventors: Hui Su, Sunnyvale, CA (US); In Suk Chong, Mountain View, CA (US)

(21) Appl. No.: 19/557,560

(22) Filed: Mar. 5, 2026

Related U.S. Application Data
(60) Provisional application No. 63/771,263, filed on Mar. 13, 2025.

(51) Int. Cl. H04N 19/119; H04N 19/157; H04N 19/176; H04N 19/70; H04N 19/91

(52) U.S. Cl. CPC H04N 19/119; H04N 19/157; H04N 19/176; H04N 19/70; H04N 19/91

(57) ABSTRACT

Decoding using partition symbol context models includes obtaining reconstructed block data by accessing entropy coded block partition data, obtaining a left binary value indicating whether a location in a vertical line buffer for entropy coding context data for block partition signaling indicates a block partition boundary, obtaining an above binary value indicating whether a location in a horizontal line buffer for entropy coding context data for block partition signaling indicates a block partition boundary, determining a context model index value in accordance with the left binary value and the above binary value, obtaining decoded block partition data for the current block by entropy decoding the entropy coded block partition data in accordance with an entropy coding context model indicated by the context model index value, and generating the reconstructed block data in accordance with the decoded block partition data.

### CROSS-REFERENCE TO RELATED APPLICATION(S)

This application claims priority to and the benefit of U.S. Provisional Application Ser. No. 63/771,263, filed Mar. 13, 2025, the entire disclosure of which is hereby incorporated by reference.

### BACKGROUND

Digital images and video can be used, for example, on the internet, for remote business meetings via video conferencing, high-definition video entertainment, video advertisements, or sharing of user-generated content. Due to the large amount of data involved in transferring and processing image and video data, high-performance compression may be advantageous for transmission and storage. Accordingly, it would be advantageous to provide high-resolution image and video transmitted over communications channels having limited bandwidth.

### SUMMARY

This application relates to encoding and decoding of image data, video stream data, or both for transmission, storage, or both. Disclosed herein are aspects of systems, methods, and apparatuses for encoding and decoding using partition symbol context models.

Variations in these and other aspects will be described in additional detail hereafter.

An aspect is a method for encoding using partition symbol context models. Encoding using partition symbol context models includes generating an encoded bitstream by encoding a current block from a current frame from an input video. Encoding the current block may include obtaining block partition data for the current block, obtaining a left binary value indicating whether a location in a vertical line buffer for entropy coding context data for block partition signaling, in a range of locations in the vertical line buffer from a first location in the vertical line buffer corresponding to a first mode information unit start value to a second location in the vertical line buffer corresponding to a first mode information unit end value, indicates a block partition boundary, obtaining an above binary value indicating whether a location in a horizontal line buffer for entropy coding context data for block partition signaling, in a range of locations in the horizontal line buffer from a first location in the horizontal line buffer corresponding to a second mode information unit start value to a second location in the horizontal line buffer corresponding to a second mode information unit end value, indicates a block partition boundary, determining a context model index value in accordance with the left binary value and the above binary value, obtaining entropy coded block partition data for the current block by entropy coding the block partition data in accordance with an entropy coding context model indicated by the context model index value, and including the entropy coded block partition data in the encoded bitstream, and outputting the encoded bitstream.

An aspect is an apparatus comprising a non-transitory computer-readable medium and a processor configured to execute instructions stored on the non-transitory computer-readable medium to perform encoding using partition symbol context models.

An aspect is a method for decoding using partition symbol context models. Decoding using partition symbol context models includes obtaining reconstructed block data for a current block of a current frame of a sequence of frames, including the reconstructed block data in reconstructed frame data for the current frame, and outputting the reconstructed frame data. Obtaining the reconstructed block data may include accessing, from an encoded bitstream, entropy coded block partition data for the current block, obtaining a left binary value indicating whether a location in a vertical line buffer for entropy coding context data for block partition signaling in a range of locations in the vertical line buffer from a first location in the vertical line buffer corresponding to a first mode information unit start value to a second location in the vertical line buffer corresponding to a first mode information unit end value, indicates a block partition boundary, obtaining an above binary value indicating whether a location in a horizontal line buffer for entropy coding context data for block partition signaling, in a range of locations in the horizontal line buffer from a first location in the horizontal line buffer corresponding to a second mode information unit start value to a second location in the horizontal line buffer corresponding to a second mode information unit end value, indicates a block partition boundary, determining a context model index value in accordance with the left binary value and the above binary value, obtaining decoded block partition data for the current block by entropy decoding the entropy coded block partition data in accordance with an entropy coding context model indicated by the context model index value, and generating the reconstructed block data in accordance with the decoded block partition data.

An aspect is an apparatus comprising a non-transitory computer-readable medium and a processor configured to execute instructions stored on the non-transitory computer-readable medium to perform decoding using partition symbol context models.

### BRIEF DESCRIPTION OF THE DRAWINGS

The description herein makes reference to the accompanying drawings wherein like reference numerals refer to like parts throughout the several views unless otherwise noted or otherwise clear from context.

FIG. 1 is a diagram of a computing device in accordance with implementations of this disclosure.

FIG. 2 is a diagram of a computing and communications system in accordance with implementations of this disclosure.

FIG. 3 is a diagram of a video stream for use in encoding and decoding in accordance with implementations of this disclosure.

FIG. 4 is a block diagram of an encoder in accordance with implementations of this disclosure.

FIG. 5 is a block diagram of a decoder in accordance with implementations of this disclosure.

FIG. 6 is a block diagram of a representation of a portion of a frame in accordance with implementations of this disclosure.

FIG. 7 is a flowchart diagram of an example of encoding using partition symbol context models in accordance with implementations of this disclosure.

FIG. 8 is a block diagram of an example of available partition types.

FIG. 9 is a flowchart diagram of an example of obtaining block partition symbols.

FIG. 10 is a block diagram of a first example of block partition context line buffers.

FIG. 11 is a block diagram of a second example of block partition context line buffers.

FIG. 12 is a flowchart diagram of an example of decoding using partition symbol context models in accordance with implementations of this disclosure.

### DETAILED DESCRIPTION

Image and video compression schemes may include breaking an image, or frame, into smaller portions, such as blocks, and generating an output bitstream using techniques to minimize the bandwidth utilization of the information included for each block in the output. In some implementations, the information included for each block in the output may be limited by reducing spatial redundancy, reducing temporal redundancy, or a combination thereof. For example, temporal or spatial redundancies may be reduced by predicting a frame, or a portion thereof, based on information available to both the encoder and decoder, and including information representing a difference, or residual, between the predicted frame and the original frame in the encoded bitstream. The residual information may be further compressed by transforming the residual information into transform coefficients (e.g., energy compaction), quantizing the transform coefficients, and entropy coding the quantized transform coefficients. Other coding information, such as motion information, may be included in the encoded bitstream, which may include transmitting differential information based on predictions of the encoding information, which may be entropy coded to further reduce the corresponding bandwidth utilization. An encoded bitstream can be decoded to reconstruct the blocks and the source images from the limited information. In some implementations, the accuracy, efficiency, or both, of coding a block using either inter-prediction or intra-prediction may be limited.

Block-based hybrid video coding techniques, or codecs, may partition a block into subblock partitions in accordance with one or more defined partitioning types. In some codecs, a vertical buffer and a horizontal buffer may be used to store partition block size data as six-bit codes per mode information unit.

The encoding and decoding using partition symbol context models described herein improves on video coding techniques, or codecs, by storing partition block size data in vertical and horizontal buffers using one bit per mode information unit, which may reduce memory utilization relative to storing the partition block size data as six-bit codes per mode information unit.

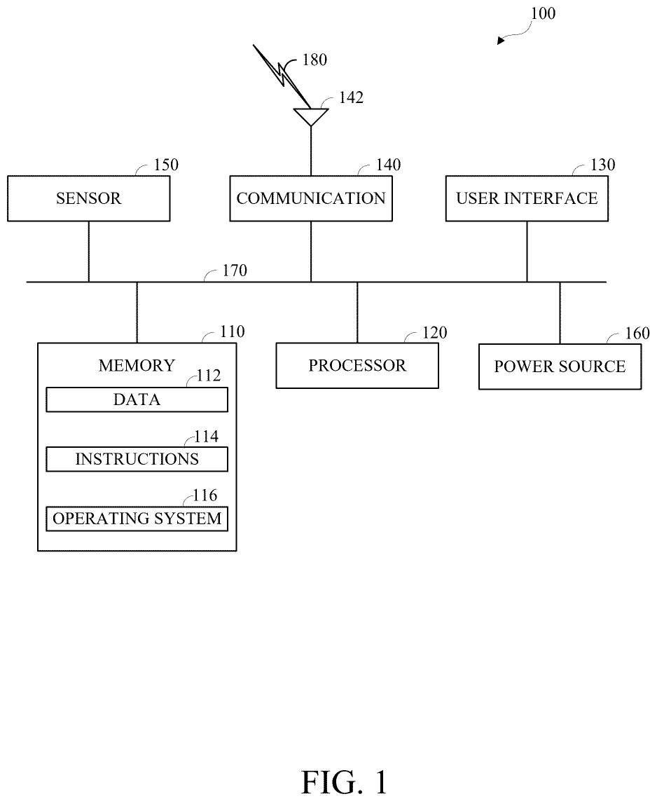

FIG. 1 is a diagram of a computing device 100 in accordance with implementations of this disclosure. The computing device 100 shown includes a memory 110, a processor 120, a user interface (UI) 130, an electronic communication unit 140, a sensor 150, a power source 160, and a bus 170. As used herein, the term “computing device” includes any unit, or a combination of units, capable of performing any method, or any portion or portions thereof, disclosed herein.

The computing device 100 may be a stationary computing device, such as a personal computer (PC), a server, a workstation, a minicomputer, or a mainframe computer; or a mobile computing device, such as a mobile telephone, a personal digital assistant (PDA), a laptop, or a tablet PC. Although shown as a single unit, any one element or elements of the computing device 100 can be integrated into any number of separate physical units. For example, the user interface 130 and processor 120 can be integrated in a first physical unit and the memory 110 can be integrated in a second physical unit.

The memory 110 can include any non-transitory computer-usable or non-transitory computer-readable medium, such as any tangible device that can, for example, contain, store, communicate, or transport data 112, instructions 114, an operating system 116, or any information associated therewith, for use by or in connection with other components of the computing device 100. The non-transitory computer-usable or computer-readable medium can be, for example, a solid-state drive, a memory card, removable media, a read-only memory (ROM), a random-access memory (RAM), any type of disk including a hard disk, a floppy disk, an optical disk, a magnetic or optical card, application-specific integrated circuits (ASICs), or any type of non-transitory media suitable for storing electronic information, or any combination thereof.

Although shown as a single unit, the memory 110 may include multiple physical units, such as one or more primary memory units, such as random-access memory units, one or more secondary data storage units, such as disks, or a combination thereof. For example, the data 112, or a portion thereof, the instructions 114, or a portion thereof, or both, may be stored in a secondary storage unit and may be loaded or otherwise transferred to a primary storage unit in conjunction with processing the respective data 112, executing the respective instructions 114, or both. In some implementations, the memory 110, or a portion thereof, may be removable memory.

The data 112 can include information, such as input audio data, encoded audio data, decoded audio data, or the like. The instructions 114 can include directions, such as code, for performing any method, or any portion or portions thereof, disclosed herein. The instructions 114 can be realized in hardware, software, or any combination thereof. For example, the instructions 114 may be implemented as information stored in the memory 110, such as a computer program, which may be executed by the processor 120 to perform any of the respective methods, algorithms, aspects, or combinations thereof, as described herein.

Although shown as included in the memory 110, in some implementations, the instructions 114, or a portion thereof, may be implemented as a special purpose processor, or circuitry, that can include specialized hardware for carrying out any of the methods, algorithms, aspects, or combinations thereof, as described herein. Portions of the instructions 114 can be distributed across multiple processors on the same machine or different machines or across a network such as a local area network, a wide area network, the Internet, or a combination thereof.

The processor 120 can include any device or system capable of manipulating or processing a digital signal or other electronic information now-existing or hereafter developed, including optical processors, quantum processors, molecular processors, or a combination thereof. For example, the processor 120 can include a special purpose processor, a central processing unit (CPU), a digital signal processor (DSP), a plurality of microprocessors, one or more microprocessor in association with a DSP core, a controller, a microcontroller, an Application Specific Integrated Circuit (ASIC), a Field Programmable Gate Array (FPGA), a programmable logic array, programmable logic controller, microcode, firmware, any type of integrated circuit (IC), a state machine, or any combination thereof. As used herein, the term “processor” includes a single processor or multiple processors.

The user interface 130 can include any unit capable of interfacing with a user, such as a virtual or physical keypad, a touchpad, a display, a touch display, a speaker, a microphone, a video camera, a sensor, or any combination thereof. For example, the user interface 130 may be an audio-visual display device, and the computing device 100 may present audio, such as decoded audio, using the user interface 130 audio-visual display device, such as in conjunction with displaying video, such as decoded video. Although shown as a single unit, the user interface 130 may include one or more physical units. For example, the user interface 130 may include an audio interface for performing audio communication with a user, and a touch display for performing visual and touch-based communication with the user.

The electronic communication unit 140 can transmit, receive, or transmit and receive signals via a wired or wireless electronic communication medium 180, such as a radio frequency (RF) communication medium, an ultraviolet (UV) communication medium, a visible light communication medium, a fiber optic communication medium, a wireline communication medium, or a combination thereof. For example, as shown, the electronic communication unit 140 is operatively connected to an electronic communication interface 142, such as an antenna, configured to communicate via wireless signals.

Although the electronic communication interface 142 is shown as a wireless antenna in FIG. 1, the electronic communication interface 142 can be a wireless antenna, as shown, a wired communication port, such as an Ethernet port, an infrared port, a serial port, or any other wired or wireless unit capable of interfacing with a wired or wireless electronic communication medium 180. Although FIG. 1 shows a single electronic communication unit 140 and a single electronic communication interface 142, any number of electronic communication units and any number of electronic communication interfaces can be used.

The sensor 150 may include, for example, an audio-sensing device, a visible light-sensing device, a motion sensing device, or a combination thereof. For example, the sensor 150 may include a sound-sensing device, such as a microphone, or any other sound-sensing device now existing or hereafter developed that can sense sounds in the proximity of the computing device 100, such as speech or other utterances, made by a user operating the computing device 100. In another example, the sensor 150 may include a camera, or any other image-sensing device now existing or hereafter developed that can sense an image such as the image of a user operating the computing device. Although a single sensor 150 is shown, the computing device 100 may include a number of sensors 150. For example, the computing device 100 may include a first camera oriented with a field of view directed toward a user of the computing device 100 and a second camera oriented with a field of view directed away from the user of the computing device 100.

The power source 160 can be any suitable device for powering the computing device 100. For example, the power source 160 can include a wired external power source interface; one or more dry cell batteries, such as nickel-cadmium (NiCd), nickel-zinc (NiZn), nickel metal hydride (NiMH), lithium-ion (Li-ion); solar cells; fuel cells; or any other device capable of powering the computing device 100. Although a single power source 160 is shown in FIG. 1, the computing device 100 may include multiple power sources 160, such as a battery and a wired external power source interface.

Although shown as separate units, the electronic communication unit 140, the electronic communication interface 142, the user interface 130, the power source 160, or portions thereof, may be configured as a combined unit. For example, the electronic communication unit 140, the electronic communication interface 142, the user interface 130, and the power source 160 may be implemented as a communications port capable of interfacing with an external display device, providing communications, power, or both.

One or more of the memory 110, the processor 120, the user interface 130, the electronic communication unit 140, the sensor 150, or the power source 160, may be operatively coupled via a bus 170. Although a single bus 170 is shown in FIG. 1, a computing device 100 may include multiple buses. For example, the memory 110, the processor 120, the user interface 130, the electronic communication unit 140, the sensor 150, and the bus 170 may receive power from the power source 160 via the bus 170. In another example, the memory 110, the processor 120, the user interface 130, the electronic communication unit 140, the sensor 150, the power source 160, or a combination thereof, may communicate data, such as by sending and receiving electronic signals, via the bus 170.

Although not shown separately in FIG. 1, one or more of the processor 120, the user interface 130, the electronic communication unit 140, the sensor 150, or the power source 160 may include internal memory, such as an internal buffer or register. For example, the processor 120 may include internal memory (not shown) and may read data 112 from the memory 110 into the internal memory (not shown) for processing.

Although shown as separate elements, the memory 110, the processor 120, the user interface 130, the electronic communication unit 140, the sensor 150, the power source 160, and the bus 170, or any combination thereof can be integrated in one or more electronic units, circuits, or chips.

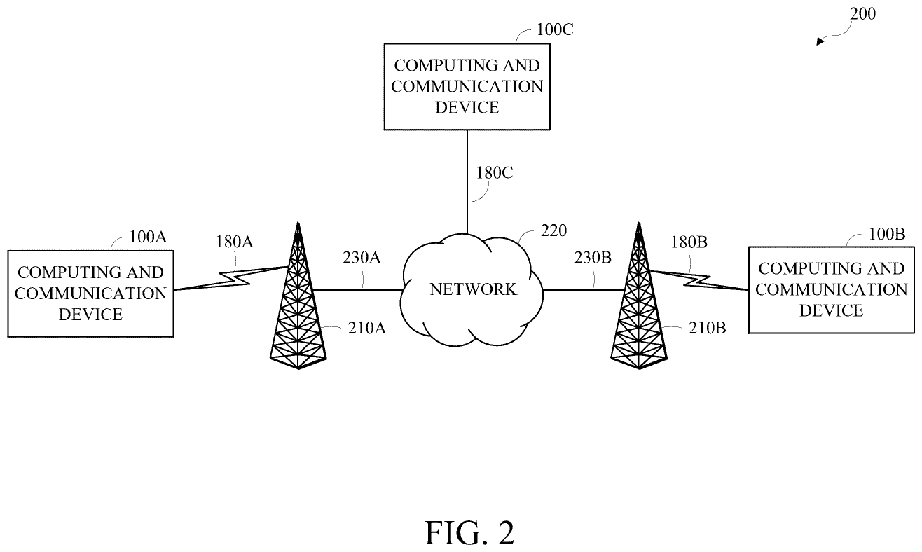

FIG. 2 is a diagram of a computing and communications system 200 in accordance with implementations of this disclosure. The computing and communications system 200 shown includes computing and communication devices 100A, 100B, 100C, access points 210A, 210B, and a network 220. For example, the computing and communication system 200 can be a multiple access system that provides communication, such as voice, audio, data, video, messaging, broadcast, or a combination thereof, to one or more wired or wireless communicating devices, such as the computing and communication devices 100A, 100B, 100C. Although, for simplicity, FIG. 2 shows three computing and communication devices 100A, 100B, 100C, two access points 210A, 210B, and one network 220, any number of computing and communication devices, access points, and networks can be used.

A computing and communication device 100A, 100B, 100C can be, for example, a computing device, such as the computing device 100 shown in FIG. 1. For example, the computing and communication devices 100A, 100B may be user devices, such as a mobile computing device, a laptop, a thin client, or a smartphone, and the computing and communication device 100C may be a server, such as a mainframe or a cluster. Although the computing and communication device 100A and the computing and communication device 100B are described as user devices, and the computing and communication device 100C is described as a server, any computing and communication device may perform some or all of the functions of a server, some, or all, of the functions of a user device, or some or all of the functions of a server and a user device. For example, the server computing and communication device 100C may receive, encode, process, store, transmit, or a combination thereof audio data and one or both of the computing and communication device 100A and the computing and communication device 100B may receive, decode, process, store, present, or a combination thereof the audio data.

Each computing and communication device 100A, 100B, 100C, which may include a user equipment (UE), a mobile station, a fixed or mobile subscriber unit, a cellular telephone, a personal computer, a tablet computer, a server, consumer electronics, or any similar device, can be configured to perform wired or wireless communication, such as via the network 220. For example, the computing and communication devices 100A, 100B, 100C can be configured to transmit or receive wired or wireless communication signals. Although each computing and communication device 100A, 100B, 100C is shown as a single unit, a computing and communication device can include any number of interconnected elements.

Each access point 210A, 210B can be any type of device configured to communicate with a computing and communication device 100A, 100B, 100C, a network 220, or both via wired or wireless communication links 180A, 180B, 180C. For example, an access point 210A, 210B can include a base station, a base transceiver station (BTS), a Node-B, an enhanced Node-B (eNode-B), a Home Node-B (HNode-B), a wireless router, a wired router, a hub, a relay, a switch, or any similar wired or wireless device. Although each access point 210A, 210B is shown as a single unit, an access point can include any number of interconnected elements.

The network 220 can be any type of network configured to provide services, such as voice, data, applications, voice over internet protocol (VOIP), or any other communications protocol or combination of communications protocols, over a wired or wireless communication link. For example, the network 220 can be a local area network (LAN), wide area network (WAN), virtual private network (VPN), a mobile or cellular telephone network, the Internet, or any other means of electronic communication. The network can use a communication protocol, such as the transmission control protocol (TCP), the user datagram protocol (UDP), the internet protocol (IP), the real-time transport protocol (RTP), the HyperText Transfer Protocol (HTTP), or a combination thereof.

The computing and communication devices 100A, 100B, 100C can communicate with each other via the network 220 using one or more wired or wireless communication links, or via a combination of wired and wireless communication links. For example, as shown the computing and communication devices 100A, 100B can communicate via wireless communication links 180A, 180B, and computing and communication device 100C can communicate via a wired communication link 180C. Any of the computing and communication devices 100A, 100B, 100C may communicate using any wired or wireless communication link, or links. For example, a first computing and communication device 100A can communicate via a first access point 210A using a first type of communication link, a second computing and communication device 100B can communicate via a second access point 210B using a second type of communication link, and a third computing and communication device 100C can communicate via a third access point (not shown) using a third type of communication link. Similarly, the access points 210A, 210B can communicate with the network 220 via one or more types of wired or wireless communication links 230A, 230B. Although FIG. 2 shows the computing and communication devices 100A, 100B, 100C in communication via the network 220, the computing and communication devices 100A, 100B, 100C can communicate with each other via any number of communication links, such as a direct wired or wireless communication link.

In some implementations, communications between one or more of the computing and communication device 100A, 100B, 100C may omit communicating via the network 220 and may include transferring data via another medium (not shown), such as a data storage device. For example, the server computing and communication device 100C may store audio data, such as encoded audio data, in a data storage device, such as a portable data storage unit, and one or both of the computing and communication device 100A or the computing and communication device 100B may access, read, or retrieve the stored audio data from the data storage unit, such as by physically disconnecting the data storage device from the server computing and communication device 100C and physically connecting the data storage device to the computing and communication device 100A or the computing and communication device 100B.

Other implementations of the computing and communications system 200 are possible. For example, in an implementation, the network 220 can be an ad-hoc network and can omit one or more of the access points 210A, 210B. The computing and communications system 200 may include devices, units, or elements not shown in FIG. 2. For example, the computing and communications system 200 may include many more communicating devices, networks, and access points.

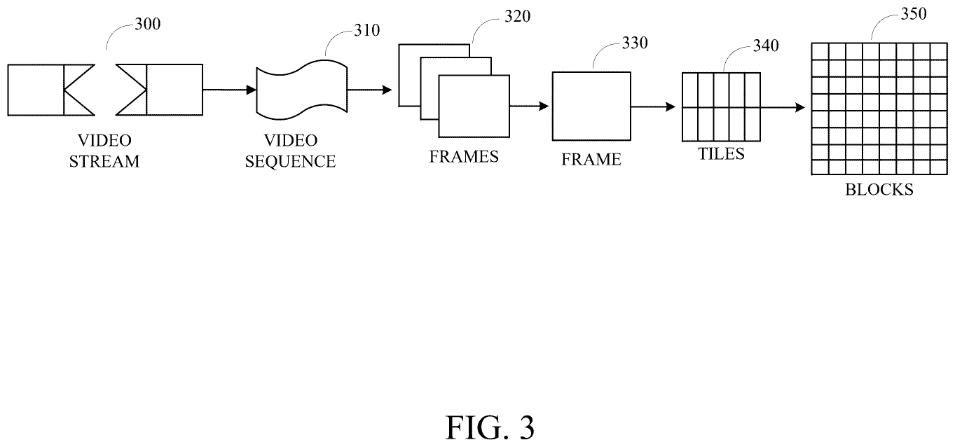

FIG. 3 is a diagram of a video stream 300 for use in encoding and decoding in accordance with implementations of this disclosure. A video stream 300, such as a video stream captured by a video camera or a video stream generated by a computing device, may include a video sequence 310. The video sequence 310 may include a sequence of adjacent frames 320. Although three adjacent frames 320 are shown, the video sequence 310 can include any number of adjacent frames 320.

Each frame 330 from the adjacent frames 320 may represent a single image from the video stream. Although not shown in FIG. 3, a frame 330 may include one or more segments, tiles, or planes, which may be coded, or otherwise processed, independently, such as in parallel. A frame 330 may include one or more tiles 340. Each of the tiles 340 may be a rectangular region of the frame that can be coded independently. Each of the tiles 340 may include respective blocks 350. Although not shown in FIG. 3, a block can include pixels. For example, a block can include a 16×16 group of pixels, an 8×8 group of pixels, an 8×16 group of pixels, or any other group of pixels. Unless otherwise indicated herein, the term ‘block’ can include a superblock, a macroblock, a segment, a slice, or any other portion of a frame. A frame, a block, a pixel, or a combination thereof can include display information, such as luminance information, chrominance information, or any other information that can be used to store, modify, communicate, or display the video stream or a portion thereof.

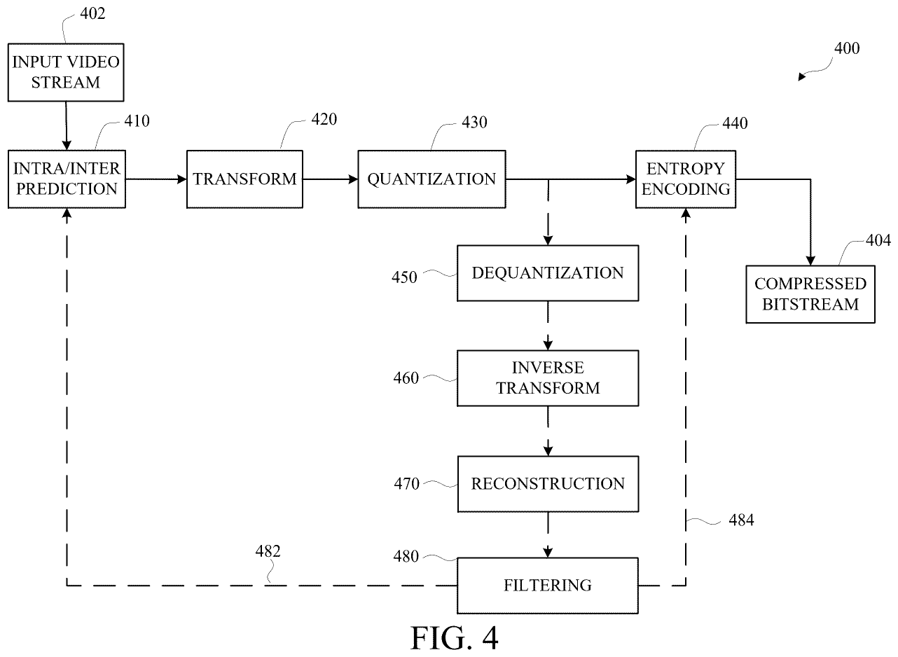

FIG. 4 is a block diagram of an encoder 400 in accordance with implementations of this disclosure. Encoder 400 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to encode video data as described herein. The encoder 400 can be implemented as specialized hardware included, for example, in computing device 100.

The encoder 400 can encode an input video stream 402, such as the video stream 300 shown in FIG. 3, to generate an encoded (compressed) bitstream 404. In some implementations, the encoder 400 may include a forward path for generating the compressed bitstream 404. The forward path may include an intra/inter prediction unit 410, a transform unit 420, a quantization unit 430, an entropy encoding unit 440, or any combination thereof. In some implementations, the encoder 400 may include a reconstruction path (indicated by the broken connection lines) to reconstruct a frame for encoding of further blocks. The reconstruction path may include a dequantization unit 450, an inverse transform unit 460, a reconstruction unit 470, a filtering unit 480, or any combination thereof. Other structural variations of the encoder 400 can be used to encode the video stream 402.

For encoding the video stream 402, each frame within the video stream 402 can be processed in units of blocks. Thus, a current block may be identified from the blocks in a frame, and the current block may be encoded.

At the intra/inter prediction unit 410, the current block can be encoded using either intra-frame prediction, which may be within a single frame, or inter-frame prediction, which may be from frame to frame. Intra-prediction may include generating a prediction block from samples in the current frame that have been previously encoded and reconstructed. Inter-prediction may include generating a prediction block from samples in one or more previously constructed reference frames. Generating a prediction block for a current block in a current frame may include performing motion estimation to generate a motion vector indicating an appropriate reference portion of the reference frame.

The intra/inter prediction unit 410 may subtract the prediction block from the current block (raw block) to produce a residual block. The transform unit 420 may perform a block-based transform, which may include transforming the residual block into transform coefficients in, for example, the frequency domain. Examples of block-based transforms include the Karhunen-Loève Transform (KLT), the Discrete Cosine Transform (DCT), the Singular Value Decomposition Transform (SVD), and the Asymmetric Discrete Sine Transform (ADST). In an example, the DCT may include transforming a block into the frequency domain. The DCT may include using transform coefficient values based on spatial frequency, with the lowest frequency (i.e., direct current (DC)) coefficient at the top-left of the matrix and the highest frequency coefficient at the bottom-right of the matrix.

The quantization unit 430 may convert the transform coefficients into discrete quantum values, which may be referred to as quantized transform coefficients or quantization levels. The quantized transform coefficients can be entropy encoded by the entropy encoding unit 440 to produce entropy-encoded coefficients. Entropy encoding can include using a probability distribution metric. The entropy-encoded coefficients and information used to decode the block, which may include the type of prediction used, motion vectors, and quantizer values, can be output to the compressed bitstream 404. The compressed bitstream 404 can be formatted using various techniques, such as run-length encoding (RLE) and zero-run coding.

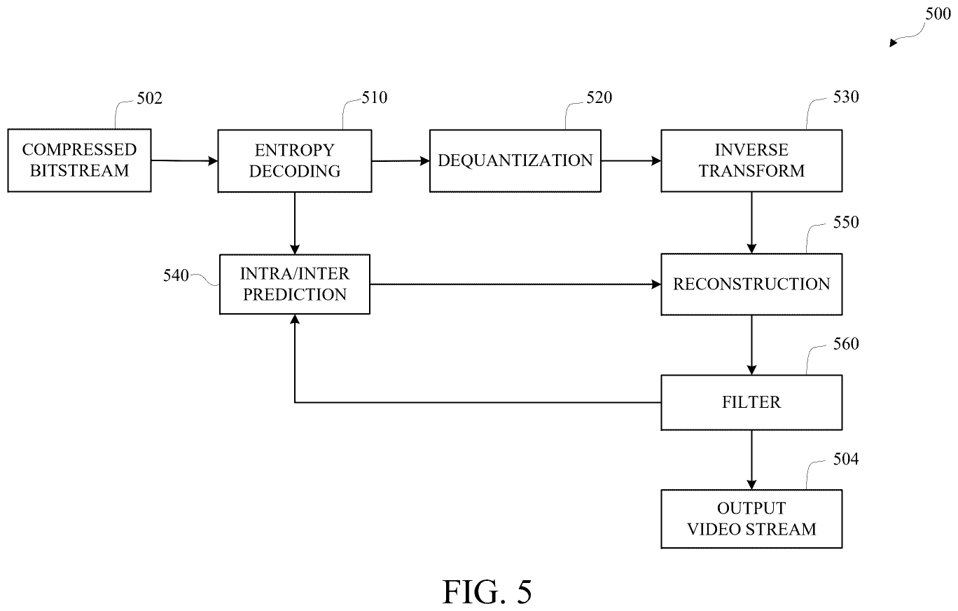

The reconstruction path can be used to maintain reference frame synchronization between the encoder 400 and a corresponding decoder, such as the decoder 500 shown in FIG. 5. The reconstruction path may be similar to the decoding process discussed below and may include decoding the encoded frame, or a portion thereof, which may include decoding an encoded block, which may include dequantizing the quantized transform coefficients at the dequantization unit 450 and inverse transforming the dequantized transform coefficients at the inverse transform unit 460 to produce a derivative residual block. The reconstruction unit 470 may add the prediction block generated by the intra/inter prediction unit 410 to the derivative residual block to create a decoded block. The filtering unit 480 can be applied to the decoded block to generate a reconstructed block, which may reduce distortion, such as blocking artifacts. Although one filtering unit 480 is shown in FIG. 4, filtering the decoded block may include loop filtering, deblocking filtering, or other types of filtering or combinations of types of filtering. The reconstructed block may be stored or otherwise made accessible as a reconstructed block, which may be a portion of a reference frame, for encoding another portion of the current frame, another frame, or both, as indicated by the broken line at 482. Coding information, such as deblocking threshold index values, for the frame may be encoded, included in the compressed bitstream 404, or both, as indicated by the broken line at 484.

Other variations of the encoder 400 can be used to encode the compressed bitstream 404. For example, a non-transform-based encoder 400 can quantize the residual block directly without the transform unit 420. In some implementations, the quantization unit 430 and the dequantization unit 450 may be combined into a single unit.

FIG. 5 is a block diagram of a decoder 500 in accordance with implementations of this disclosure. The decoder 500 can be implemented in a device, such as the computing device 100 shown in FIG. 1 or the computing and communication devices 100A, 100B, 100C shown in FIG. 2, as, for example, a computer software program stored in a data storage unit, such as the memory 110 shown in FIG. 1. The computer software program can include machine instructions that may be executed by a processor, such as the processor 120 shown in FIG. 1, and may cause the device to decode video data as described herein. The decoder 500 can be implemented as specialized hardware included, for example, in computing device 100.

The decoder 500 may receive a compressed bitstream 502, such as the compressed bitstream 404 shown in FIG. 4, and may decode the compressed bitstream 502 to generate an output video stream 504. The decoder 500 may include an entropy decoding unit 510, a dequantization unit 520, an inverse transform unit 530, an intra/inter prediction unit 540, a reconstruction unit 550, a filtering unit 560, or any combination thereof. Other structural variations of the decoder 500 can be used to decode the compressed bitstream 502.

The entropy decoding unit 510 may decode data elements within the compressed bitstream 502 using, for example, Context Adaptive Binary Arithmetic Decoding, to produce a set of quantized transform coefficients. The dequantization unit 520 can dequantize the quantized transform coefficients, and the inverse transform unit 530 can inverse transform the dequantized transform coefficients to produce a derivative residual block, which may correspond to the derivative residual block generated by the inverse transform unit 460 shown in FIG. 4. Using header information decoded from the compressed bitstream 502, the intra/inter prediction unit 540 may generate a prediction block corresponding to the prediction block created in the encoder 400. At the reconstruction unit 550, the prediction block can be added to the derivative residual block to create a decoded block. The filtering unit 560 can be applied to the decoded block to reduce artifacts, such as blocking artifacts, which may include loop filtering, deblocking filtering, or other types of filtering or combinations of types of filtering, and which may include generating a reconstructed block, which may be output as the output video stream 504.

Other variations of the decoder 500 can be used to decode the compressed bitstream 502. For example, the decoder 500 can produce the output video stream 504 without the deblocking filtering unit 560.

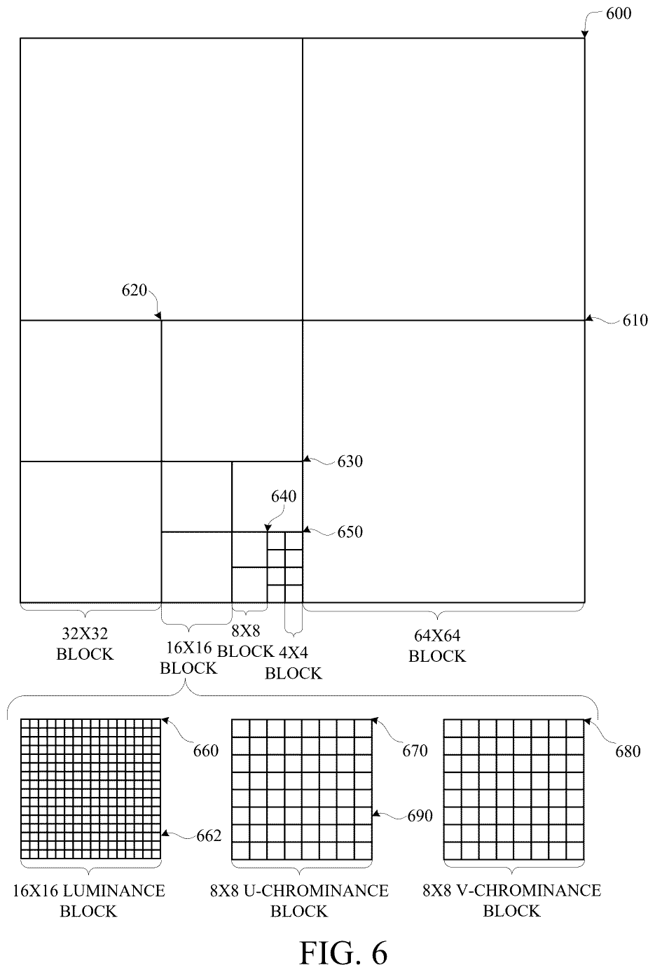

FIG. 6 is a block diagram of a representation of a portion 600 of a frame, such as the frame 330 shown in FIG. 3, in accordance with implementations of this disclosure. As shown, the portion 600 of the frame includes four 64×64 blocks 610, in two rows and two columns in a matrix or Cartesian plane. In some implementations, a 64×64 block may be a maximum coding unit, N-64. Each 64×64 block may include four 32×32 blocks 620. Each 32×32 block may include four 16×16 blocks 630. Each 16×16 block may include four 8×8 blocks 640. Each 8×8 block 640 may include four 4×4 blocks 650. Each 4×4 block 650 may include 16 pixels, which may be represented in four rows and four columns in each respective block in the Cartesian plane or matrix. The pixels may include information representing an image captured in the frame, such as luminance information, color information, and location information. In some implementations, a block, such as a 16×16 pixel block as shown, may include a luminance block 660, which may include luminance pixels 662; and two chrominance blocks 670, 680, such as a U or Cb chrominance block 670, and a V or Cr chrominance block 680. The chrominance blocks 670, 680 may include chrominance pixels 690. For example, the luminance block 660 may include 16×16 luminance pixels 662 and each chrominance block 670, 680 may include 8×8 chrominance pixels 690 as shown. Although one arrangement of blocks is shown, any arrangement may be used. Although FIG. 6 shows N×N blocks, in some implementations, N×M blocks may be used. For example, 32×64 blocks, 64×32 blocks, 16×32 blocks, 32×16 blocks, or any other size blocks may be used. In some implementations, N×2N blocks, 2N×N blocks, or a combination thereof may be used.

In some implementations, video coding may include ordered block-level coding. Ordered block-level coding may include coding blocks of a frame in an order, such as raster-scan order, wherein blocks may be identified and processed starting with a block in the upper left corner of the frame, or portion of the frame, and proceeding along rows from left to right and from the top row to the bottom row, identifying each block in turn for processing. For example, the 64×64 block in the top row and left column of a frame may be the first block coded and the 64×64 block immediately to the right of the first block may be the second block coded. The second row from the top may be the second row coded, such that the 64×64 block in the left column of the second row may be coded after the 64×64 block in the rightmost column of the first row.

In some implementations, coding a block may include using quad-tree coding, which may include coding smaller block units within a block in raster-scan order. For example, the 64×64 block shown in the bottom left corner of the portion of the frame shown in FIG. 6, may be coded using quad-tree coding wherein the top left 32×32 block may be coded, then the top right 32×32 block may be coded, then the bottom left 32×32 block may be coded, and then the bottom right 32×32 block may be coded. Each 32×32 block may be coded using quad-tree coding wherein the top left 16×16 block may be coded, then the top right 16×16 block may be coded, then the bottom left 16×16 block may be coded, and then the bottom right 16×16 block may be coded. Each 16×16 block may be coded using quad-tree coding wherein the top left 8×8 block may be coded, then the top right 8×8 block may be coded, then the bottom left 8×8 block may be coded, and then the bottom right 8×8 block may be coded. Each 8×8 block may be coded using quad-tree coding wherein the top left 4×4 block may be coded, then the top right 4×4 block may be coded, then the bottom left 4×4 block may be coded, and then the bottom right 4×4 block may be coded. In some implementations, 8×8 blocks may be omitted for a 16×16 block, and the 16×16 block may be coded using quad-tree coding wherein the top left 4×4 block may be coded, then the other 4×4 blocks in the 16×16 block may be coded in raster-scan order.

In some implementations, video coding may include compressing the information included in an original, or input, frame by, for example, omitting some of the information in the original frame from a corresponding encoded frame. For example, coding may include reducing spectral redundancy, reducing spatial redundancy, reducing temporal redundancy, or a combination thereof.

In some implementations, reducing spectral redundancy may include using a color model based on a luminance component (Y) and two chrominance components (U and V or Cb and Cr), which may be referred to as the YUV or YCbCr color model, or color space. Using the YUV color model may include using a relatively large amount of information to represent the luminance component of a portion of a frame and using a relatively small amount of information to represent each corresponding chrominance component for the portion of the frame. For example, a portion of a frame may be represented by a high-resolution luminance component, which may include a 16×16 block of pixels, and by two lower resolution chrominance components, each of which represents the portion of the frame as an 8×8 block of pixels. A pixel may indicate a value, for example, a value in the range from 0 to 255, and may be stored or transmitted using, for example, eight bits. Although this disclosure is described in reference to the YUV color model, any color model may be used.

In some implementations, reducing spatial redundancy may include transforming a block into the frequency domain using, for example, a discrete cosine transform (DCT). For example, a unit of an encoder, such as the transform unit 420 shown in FIG. 4, may perform a DCT using transform coefficient values based on spatial frequency.

In some implementations, reducing temporal redundancy may include using similarities between frames to encode a frame using a relatively small amount of data based on one or more reference frames, which may be previously encoded, decoded, and reconstructed frames of the video stream. For example, a block or pixel of a current frame may be similar to a spatially corresponding block or pixel of a reference frame. In some implementations, a block or pixel of a current frame may be similar to block or pixel of a reference frame at a different spatial location and reducing temporal redundancy may include generating motion information indicating the spatial difference, or translation, between the location of the block or pixel in the current frame and corresponding location of the block or pixel in the reference frame.

In some implementations, reducing temporal redundancy may include identifying a portion of a reference frame that corresponds to a current block or pixel of a current frame. For example, a reference frame, or a portion of a reference frame, which may be stored in memory, may be searched to identify a portion for generating a prediction to use for encoding a current block or pixel of the current frame with maximal efficiency. For example, the search may identify a portion of the reference frame for which the difference in pixel values between the current block and a prediction block generated based on the portion of the reference frame is minimized and may be referred to as motion searching. In some implementations, the portion of the reference frame searched may be limited. For example, the portion of the reference frame searched, which may be referred to as the search area, may include a limited number of rows of the reference frame. In an example, identifying the portion of the reference frame for generating a prediction may include calculating a cost function, such as a sum of absolute differences (SAD), between the pixels of portions of the search area and the pixels of the current block.

In some implementations, the spatial difference between the location of the portion of the reference frame for generating a prediction in the reference frame and the current block in the current frame may be represented as a motion vector. The difference in pixel values between the prediction block and the current block may be referred to as differential data, residual data, a prediction error, or as a residual block. In some implementations, generating motion vectors may be referred to as motion estimation, and a pixel of a current block may be indicated based on location using Cartesian coordinates as f_{X, y}. Similarly, a pixel of the search area of the reference frame may be indicated based on location using Cartesian coordinates as r_{X, y}. A motion vector (MV) for the current block may be determined based on, for example, a SAD between the pixels of the current frame and the corresponding pixels of the reference frame.

Although described herein with reference to matrix or Cartesian representation of a frame for clarity, a frame may be stored, transmitted, processed, or any combination thereof, in any data structure such that pixel values may be efficiently represented for a frame or image. For example, a frame may be stored, transmitted, processed, or any combination thereof, in a two-dimensional data structure such as a matrix as shown, or in a one-dimensional data structure, such as a vector array. In an implementation, a representation of the frame, such as a two-dimensional representation as shown, may correspond to a physical location in a rendering of the frame as an image. For example, a location in the top left corner of a block in the top left corner of the frame may correspond with a physical location in the top left corner of a rendering of the frame as an image.

In some implementations, block-based coding efficiency may be improved by partitioning input blocks into one or more prediction partitions, which may be rectangular, including square, partitions for prediction coding. In some implementations, video coding using prediction partitioning may include selecting a prediction partitioning scheme from among multiple candidate prediction partitioning schemes. For example, in some implementations, candidate prediction partitioning schemes for a 64×64 coding unit may include rectangular size prediction partitions ranging in sizes from 4×4 to 64×64, such as 4×4, 4×8, 8×4, 8×8, 8×16, 16×8, 16×16, 16×32, 32×16, 32×32, 32×64, 64×32, or 64×64. In some implementations, video coding using prediction partitioning may include a full prediction partition search, which may include selecting a prediction partitioning scheme by encoding the coding unit using each available candidate prediction partitioning scheme and selecting the best scheme, such as the scheme that produces the least rate-distortion error.

In some implementations, encoding a video frame may include identifying a prediction partitioning scheme for encoding a current block, such as block 610. In some implementations, identifying a prediction partitioning scheme may include determining whether to encode the block as a single prediction partition of maximum coding unit size, which may be 64×64 as shown, or to partition the block into multiple prediction partitions, which may correspond with the sub-blocks, such as the 32×32 blocks 620, the 16×16 blocks 630, or the 8×8 blocks 640, as shown, and may include determining whether to partition into one or more smaller prediction partitions. For example, a 64×64 block may be partitioned into four 32×32 prediction partitions. Three of the four 32×32 prediction partitions may be encoded as 32×32 prediction partitions and the fourth 32×32 prediction partition may be further partitioned into four 16×16 prediction partitions. Three of the four 16×16 prediction partitions may be encoded as 16×16 prediction partitions and the fourth 16×16 prediction partition may be further partitioned into four 8×8 prediction partitions, each of which may be encoded as an 8×8 prediction partition. In some implementations, identifying the prediction partitioning scheme may include using a prediction partitioning decision tree.

In some implementations, video coding for a current block may include identifying an optimal prediction coding mode from multiple candidate prediction coding modes, which may provide flexibility in handling video signals with various statistical properties and may improve the compression efficiency. For example, a video coder may evaluate each candidate prediction coding mode to identify the optimal prediction coding mode, which may be, for example, the prediction coding mode that minimizes an error metric, such as a rate-distortion cost, for the current block. In some implementations, the complexity of searching the candidate prediction coding modes may be reduced by limiting the set of available candidate prediction coding modes based on similarities between the current block and a corresponding prediction block. In some implementations, the complexity of searching each candidate prediction coding mode may be reduced by performing a directed refinement mode search. For example, metrics may be generated for a limited set of candidate block sizes, such as 16×16, 8×8, and 4×4, the error metric associated with each block size may be in descending order, and additional candidate block sizes, such as 4×8 and 8×4 block sizes, may be evaluated.

In some implementations, block-based coding efficiency may be improved by partitioning a current residual block into one or more transform partitions, which may be rectangular, including square, partitions for transform coding. In some implementations, video coding, such as video coding using transform partitioning, may include selecting a uniform transform partitioning scheme. For example, a current residual block, such as block 610, may be a 64×64 block and may be transformed without partitioning using a 64×64 transform.

Although not expressly shown in FIG. 6, a residual block may be transform partitioned using a uniform transform partitioning scheme. For example, a 64×64 residual block may be transform partitioned using a uniform transform partitioning scheme including four 32×32 transform blocks, using a uniform transform partitioning scheme including sixteen 16×16 transform blocks, using a uniform transform partitioning scheme including sixty-four 8×8 transform blocks, or using a uniform transform partitioning scheme including 256 4×4 transform blocks.

In some implementations, video coding, such as video coding using transform partitioning, may include identifying multiple transform block sizes for a residual block using multiform transform partition coding. In some implementations, multiform transform partition coding may include recursively determining whether to transform a current block using a current block size transform or by partitioning the current block and multiform transform partition coding each partition. For example, the bottom left block 610 shown in FIG. 6 may be a 64×64 residual block, and multiform transform partition coding may include determining whether to code the current 64×64 residual block using a 64×64 transform or to code the 64×64 residual block by partitioning the 64×64 residual block into partitions, such as four 32×32 blocks 620, and multiform transform partition coding each partition. In some implementations, determining whether to transform partition the current block may be based on comparing a cost for encoding the current block using a current block size transform to a sum of costs for encoding each partition using partition size transforms.

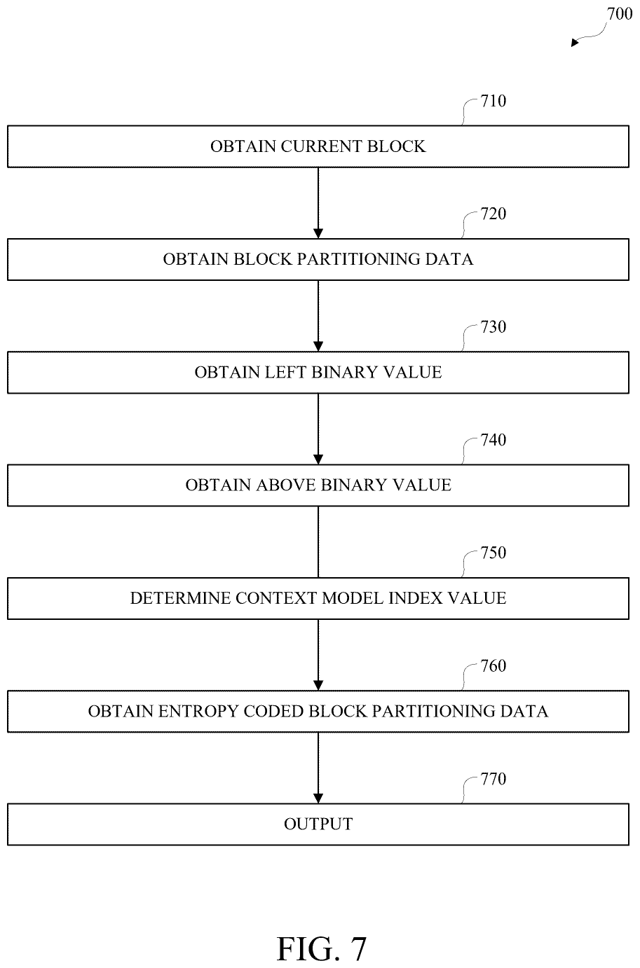

FIG. 7 is a flowchart diagram of an example of encoding using partition symbol context models 700 in accordance with implementations of this disclosure. Encoding using partition symbol context models 700 may be implemented in an encoder, such as the encoder 400 shown in FIG. 4, or one or more portions thereof.

Encoding using partition symbol context models 700 includes generating an encoded bitstream by encoding a current block from a current frame from an input video, such as the input video stream 402 shown in FIG. 4, or one or more portions thereof, to generate an encoded (compressed) output bitstream, such as the encoded (compressed) bitstream 404 shown in FIG. 4, or one or more portions thereof. In block-based hybrid video coding, to reduce, or minimize, the resource utilization, such as bandwidth utilization, for signaling, storing, or both, compressed, or encoded, video data, redundant data, such as spatially redundant data, temporally redundant data, or both, is omitted or excluded from the compressed, or encoded, data. For example, spatial redundancy may be reduced using intra prediction, wherein the current block is predicted from the current frame. In another example, temporal redundancy may be reduced using inter prediction, wherein the current block is predicted from one or more reference frames, which may be previously decoded (and reconstructed) frames, constructed reference frames, or both.

Encoding using partition symbol context models 700 includes generating an encoded bitstream by encoding the current block from the current frame from the input video.

Encoding using partition symbol context models 700 includes obtaining a current block (at 710), obtaining block partition data (at 720), obtaining a left binary value (at 730), obtaining an above binary value (at 740), determining a context model index value (at 750), obtaining entropy coded block partition data (at 760), and outputting an encoded bitstream (at 770).

The current frame is obtained (at 710). The current frame is a frame from the input video, or input video stream. In some implementations, the input video stream may include one or more sequences of frames. A sequence of frames may have a defined cardinality, or number, of frames. For example, the encoder, or a component thereof, such as an intra/inter prediction unit of the encoder, such as the intra/inter prediction unit 410 shown in FIG. 4, may obtain the input video stream. The current frame may be obtained (at 710) subsequent to encoding one or more other frames, such as a frame sequentially preceding the current frame in the input video stream, and generating, or otherwise obtaining, a corresponding reconstructed frame (or frames), or one or more portions thereof, for use as a reference frame (or frames) for encoding the current frame.

The current block is obtained (at 710) from the current frame. Although not shown separately in FIG. 7, encoding using partition symbol context models 700 may include encoding, reconstructing, or both, one or more portions of the current frame prior to encoding the current block.

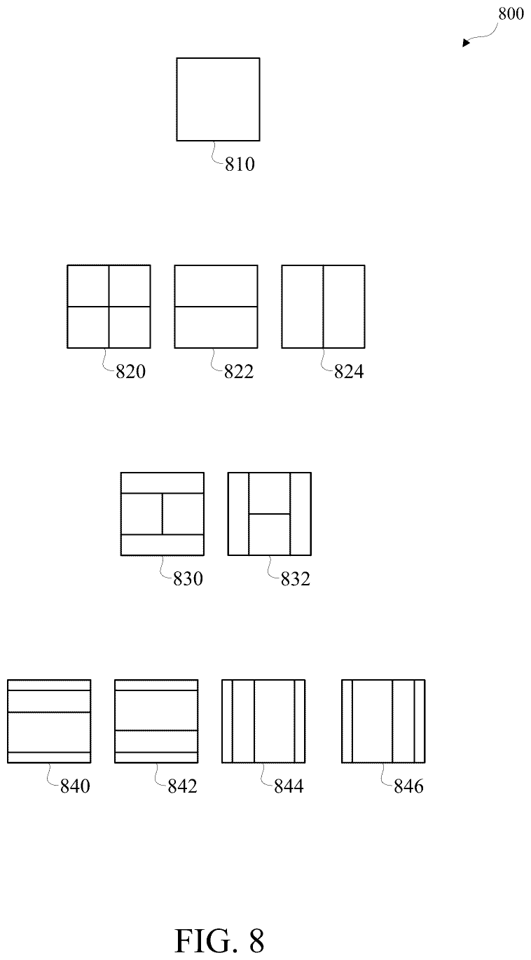

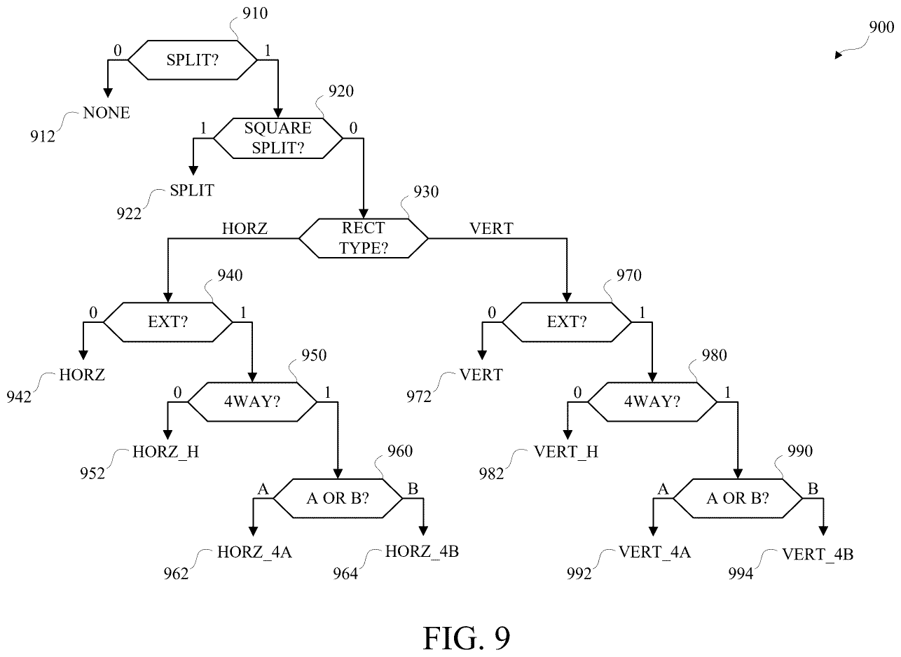

Obtaining the block partition data (at 720) includes obtaining the block partition data to indicate a partition type for the current block from among available partition types. An example of available partition types is shown in FIG. 8. An example of obtaining the block partition data is shown in FIG. 9.

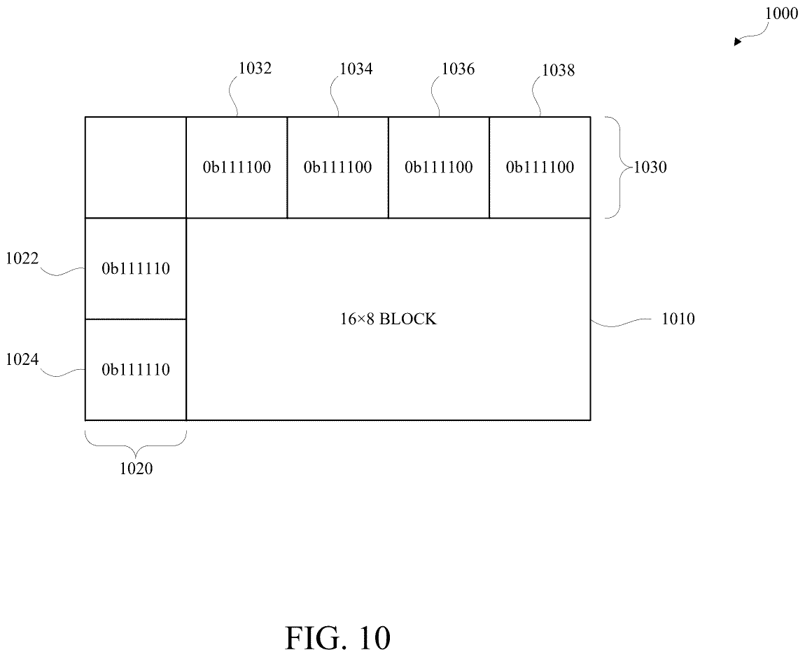

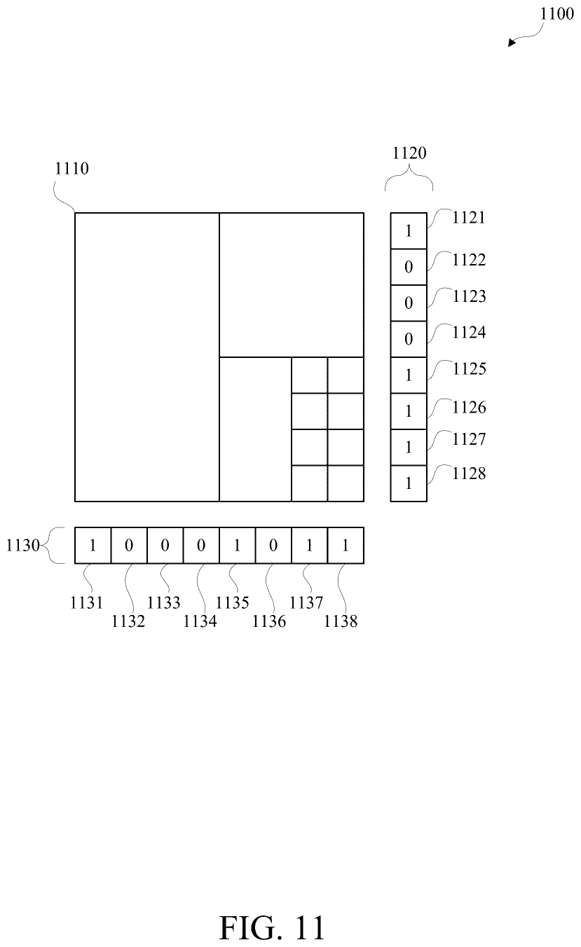

Obtaining the left binary value (at 730) includes obtaining a vertical line buffer for entropy coding context data for block partition signaling. A first example of a vertical line buffer is shown in FIG. 10. A second example of a vertical line buffer is shown in FIG. 11.

The vertical line buffer includes data stored in accordance with coding one or more blocks of the current frame prior to coding the current block, such as one or more blocks to the left of the current block.

The vertical line buffer has a defined size indicating a defined number, count, or cardinality of locations, such as sixty-four (64) locations. The locations in the vertical line buffer respectively correspond to mode information units of the current frame, such as on a one-to-one basis. A mode information unit has a defined spatial, or pixel domain, size, such as four pixels by four pixels. Mode information units in the current frame are indexed vertically, such as in top-down order by rows of mode information units, such that a respective mode information unit corresponds to a respective mode information unit row index value.

In some implementations, as shown in FIG. 10, a location in the vertical line buffer, corresponding to a mode information (MI) unit, includes six bits, such as a six-bit code, for storing partition block size data indicating a spatial, or pixel domain, vertical size of a previously coded block that includes the mode information unit corresponding to the location in the vertical line buffer. In implementations wherein a location in the vertical line buffer includes six bits for storing partition block size data, such as shown in FIG. 10, the left binary value may be one (left=1), indicating that a block size of a block to the left of the current block, such as neighboring or adjacent to the current block, is smaller than the block size of the current block, or zero (left=0), indicating that the block size of the block to the left of the current block, such as neighboring or adjacent to the current block, is equal to or greater than the block size of the current block.

In some implementations, as shown in FIG. 11, a location in the vertical line buffer, corresponding to a mode information (MI) unit, includes one bit for storing data (block partition data) indicating whether a block boundary of a previously coded block that includes the mode information unit corresponding to the location in the vertical line buffer is aligned with a defined boundary of the mode information unit, such as a top boundary of the mode information unit. For example, a first value of the bit, such as one, may indicate that the top boundary of the mode information unit is aligned with a boundary of the previously coded block. In another example, a second value, such as zero, of the bit may indicate that the top boundary of the mode information unit is unaligned with a boundary of the previously coded block. Except as is described herein or as is otherwise clear from context, the vertical line buffer described herein includes one bit per location for storing block partition data.

Obtaining the left binary value (at 730) includes obtaining, determining, or deriving, the left binary value indicating whether a location in the vertical line buffer, in a range of locations in the vertical line buffer from a first location in the vertical line buffer corresponding to a first mode information unit start value to a second location in the vertical line buffer corresponding to a first mode information unit end value, indicates a block partition boundary.

The first mode information unit start value is a sum of a mode information unit row index value for a top-left mode information unit of the current block and one.

The first mode information unit end value is a sum of the first mode information unit start value and a first mode information unit length value, wherein the first mode information unit length value is a result of subtracting one from a height of the current block in mode information units.

For example, one may be obtained as the left binary value in response to a determination that at least one location in the range of locations in the vertical line buffer stores a value of one. In another example, one may be obtained as the above binary value in response to a determination that at least one location in the range of locations in the horizontal line buffer stores a value of one. In another example, zero may be obtained as the left binary value in response to a determination that bits stored in the range of locations in the vertical line buffer having a value of one are absent. In another example, zero may be obtained as the above binary value in response to a determination that bits stored in the range of locations in the horizontal line buffer having a value of one are absent.

In some implementations, obtaining the left binary value (left) may include using a detect boundary function (detect_boundary). The detect boundary function may have a line buffer input parameter (context_line_buffer) corresponding to a line buffer, a mode information unit start input parameter (mi_start), and a mode information unit length input parameter (mi_len). Obtaining the left binary value (left) using the detect boundary function (detect_boundary) may include using the vertical line buffer (left_context_line_buffer) as the line buffer input parameter (context_line_buffer), using the sum of the mode information unit row index value (mi_row) for the top-left mode information unit of the current block and one as the mode information unit start input parameter (mi_start), and using the result of subtracting one from the height of the current block in mode information units (mi_height) as the mode information unit length input parameter (mi_len), which may be expressed as the following:

$$left = detect\_boundary ( left\_context \_line \_buffer , mi\_row + 1 , mi\_height - 1 ) .$$

In some implementations, obtaining the left binary value includes obtaining, as the left binary value, a result of a bit masking AND operation with respect to the bits stored in the range of locations in the vertical line buffer. For example, the detect boundary function may implement the bit masking AND operation.

In some implementations, obtaining the above binary value includes obtaining, as the above binary value, a result of a bit masking AND operation with respect to bits stored in the range of locations in the horizontal line buffer. For example, the detect boundary function may implement the bit masking AND operation. A respective location from the range of locations in the vertical line buffer stores one bit. A respective location from the range of locations in the horizontal line buffer stores one bit.

Obtaining the above binary value (at 740) includes obtaining a horizontal line buffer for entropy coding context data for block partition signaling. A first example of a horizontal line buffer is shown in FIG. 10. A second example of a horizontal line buffer is shown in FIG. 11.

The horizontal line buffer includes data stored in accordance with coding one or more blocks of the current frame prior to coding the current block, such as one or more blocks above the current block.

The horizontal line buffer has a size indicating a number, count, or cardinality of locations. The locations in the horizontal line buffer respectively correspond to mode information units of the current frame, such as on a one-to-one basis. The mode information units in the current frame are indexed horizontally, such as in left-to-right order by columns of mode information units, such that a respective mode information unit corresponds to a respective mode information unit column index value. The size of the horizontal line buffer corresponds to the horizontal size in mode information units, such as a tile width in mode information units, of a tile (current tile) that includes the current block.

In some implementations, as shown in FIG. 10, a location in the horizontal line buffer, corresponding to a mode information (MI) unit, includes six bits for storing partition block size data indicating a spatial, or pixel domain, horizontal size of a previously coded block that includes the mode information unit corresponding to the location in the horizontal line buffer. In implementations wherein a location in the horizontal line buffer includes six bits for storing partition block size data, such as shown in FIG. 10, the above binary value may be one (above=1), indicating that a block size of a block above the current block, such as neighboring or adjacent to the current block, is smaller than the block size of the current block, or zero (above=0), indicating that the block size of the block above the current block, such as neighboring or adjacent to the current block, is equal to or greater than the block size of the current block.

In some implementations, as shown in FIG. 11, a location in the horizontal line buffer, corresponding to a mode information (MI) unit, includes one bit for storing data (block partition data) indicating whether a block boundary of a previously coded block that includes the mode information unit corresponding to the location in the horizontal line buffer is aligned with a defined boundary of the mode information unit, such as a left boundary of the mode information unit. For example, a first value of the bit, such as one, may indicate that the left boundary of the mode information unit is aligned with a boundary of the previously coded block. In another example, a second value, such as zero, of the bit may indicate that the left boundary of the mode information unit is unaligned with a boundary of the previously coded block. Except as is described herein or as is otherwise clear from context, the horizontal line buffer described herein includes one bit per location for storing block partition data.

Obtaining the above binary value (at 740) includes obtaining, determining, or deriving, the above binary value indicating whether a location in the horizontal line buffer, in a range of locations in the horizontal line buffer from a first location in the horizontal line buffer corresponding to a second mode information unit start value to a second location in the horizontal line buffer corresponding to a second mode information unit end value, indicates a block partition boundary.

The second mode information unit start value (mi_start) is a sum of a mode information unit column index value (mi_col) for a top-left mode information unit of the current block and one (mi_col+1).

The second mode information unit end value (mi_end) is a sum of the second mode information unit start value (mi_start) and a second mode information unit length value (mi_len), wherein the second mode information unit length value (mi_len) is a result of subtracting one from a width of the current block in mode information units (mi_width) (mi_width-1).

In some implementations, obtaining the above binary value (above) may include using the detect boundary function (detect_boundary). Obtaining the above binary value (above) using the detect boundary function (detect_boundary) may include using the horizontal line buffer (above_context_line_buffer) as the line buffer input parameter (context_line_buffer), using the sum of the mode information unit column index value (mi_col) for the top-left mode information unit of the current block and one as the mode information unit start input parameter (mi_start), and using the result of subtracting one from the width of the current block in mode information units (mi_width) as the mode information unit length input parameter (mi_len), which may be expressed as the following:

$$above = detect\_boundary ( above\_context \_line \_buffer , mi\_col + 1 , mi\_width - 1 ) .$$

Determining the context model index value (at 750) includes determining the context model index value in accordance with the left binary value and the above binary value.

Determining the context model index value in accordance with the left binary value and the above binary value includes obtaining, as the context model index value, a sum of a product of multiplying a block size group index value for the current block by four, a product of multiplying the left binary value (left) by two, and the above binary value (above). The block size group index value for the current block may be obtained from a table, or other data structure, (block_size group mapping) that maps block sizes to group index values. For example, determining the context model index value (CTX), wherein the current block has a current block size (block size), may be expressed as the following:

$$CTX = block\_size \_group \_mapping [ block\_size ] * 4 + 2 * left + above .$$

Although obtaining the left binary value (at 730) and obtaining the above binary value (at 740) are shown separately and before determining the context model index value (at 750), determining the context model index value (at 750) may include obtaining the left binary value (at 730) and obtaining the above binary value (at 740).

Obtaining the entropy coded block partition data (at 760) includes obtaining the entropy coded block partition data for the current block by entropy coding the block partition data in accordance with an entropy coding context model indicated by the context model index value.

The entropy coded block partition data is included in the encoded bitstream and the encoded bitstream is output (at 770).

Although not expressly shown in FIG. 7, in some implementations obtaining the encoded block data may include, subsequent to determining the context model index value, storing a binary value of one in a location in the vertical line buffer corresponding to a top-left mode information unit of the current block, storing a binary value of one in a location in the horizontal line buffer corresponding to the top-left mode information unit, on a condition that a height of the current block in mode information units is greater than one, storing binary values (store binary values) of zero in locations in the vertical line buffer corresponding to mode information units of the current block other than the top-left mode information unit, and on a condition that a width of the current block in mode information units is greater than one, storing binary values of zero in locations in the horizontal line buffer corresponding to mode information units of the current block other than the top-left mode information unit.

Although not expressly shown in FIG. 7, in implementations wherein a location in the horizontal line buffer or the vertical line buffer includes six bits for storing partition block size data, such as shown in FIG. 10, obtaining the encoded block data may include, subsequent to determining the context model index value, storing a six-bit value or code indicating a horizontal, with respect to the horizontal line buffer, or vertical, with respect to the vertical line buffer, partition block size for the current block. The available partition block sizes are mapped to respective six-bit codes in accordance with Table 1 and Table 2.

Table 1 indicates the semantics of the mapping between block sizes and corresponding six-bit codes, such as in implementations wherein a location in the horizontal line buffer or the vertical line buffer includes six bits for storing partition block size data, such as shown in FIG. 10.

TABLE 1

| Bit index | 5 | 4 | 3 | 2 | 1 | 0 |
|---|---|---|---|---|---|---|
| Semantics | Smaller | Smaller | Smaller | Smaller | Smaller | Smaller |
| | than 256? | than 128? | than 64? | than 32? | than 16? | than 8? |

Table 2 indicates the mapping between block sizes and corresponding six-bit codes, such as in implementations wherein a location in the horizontal line buffer or the vertical line buffer includes six bits for storing partition block size data, such as shown in FIG. 10.

TABLE 2

| Block size | Binary code | Decimal code |
|---|---|---|
| 4 | 0b111111 | 63 |
| 8 | 0b111110 | 62 |
| 16 | 0b111100 | 60 |
| 32 | 0b111000 | 56 |
| 64 | 0b110000 | 48 |
| 128 | 0b100000 | 32 |
| 256 | 0b000000 | 0 |

For example, in implementations wherein a location in the horizontal line buffer or the vertical line buffer includes six bits for storing partition block size data, such as shown in FIG. 10, obtaining the encoded block data may include, subsequent to determining the context model index value, obtaining a six-bit code corresponding to the width of the current block, such as from Table 2, and storing the six-bit code in one or more locations in the horizontal line buffer corresponding to mode information units corresponding to the current block and obtaining a six-bit code corresponding to the height of the current block, such as from Table 2, and storing the six-bit code in one or more locations in the vertical line buffer corresponding to mode information units corresponding to the current block.

In implementations wherein a location in the horizontal line buffer or the vertical line buffer includes six bits for storing partition block size data, such as shown in FIG. 10, obtaining the left binary value (left) and the above binary value (above) may include using bitwise shift and AND operations.

FIG. 8 is a block diagram of an example of available partition types 800 for partitioning a current block.

The available partition types 800 include an unpartitioned partition type 810 (none, partition_none), wherein the current block is unpartitioned. Further partitioning for the current block may be omitted, skipped, or excluded.

The available partition types 800 include a split partition type 820 (SPLIT or PARTITION_SPLIT) wherein the current block is partitioned horizontally and vertically with quadrilateral symmetry into four subblock partitions (subblocks), such as square subblocks.

The available partition types 800 include a horizontal partition type 822 (HORZ or PARTITION_HORZ) wherein the current block is partitioned horizontally into two symmetrical subblock partitions, such as horizontal rectangular subblocks.

The available partition types 800 include a vertical partition type 824 (VERT or PARTITION_VERT) wherein the current block is partitioned vertically into two symmetrical subblock partitions, such as vertical rectangular subblocks.

The available partition types 800 include a horizontal-H partition type 830 (HORZ_H or PARTITION_HORZ_H) wherein the current block is partitioned horizontally and vertically with bilateral symmetry into four subblock partitions (subblocks), including a first horizontal rectangular partition corresponding to the top of the current block and having the width of the current block and one-fourth of the height of the current block, a second horizontal rectangular partition corresponding to the bottom of the current block and having the width of the current block and one-fourth of the height of the current block, a left partition having half the width of the current block and half of the height of the current block, and a right partition having half the width of the current block and half of the height of the current block.

The available partition types 800 include a vertical-H partition type 832 (VERT_H or PARTITION_VERT_H) wherein the current block is partitioned vertically and horizontally with bilateral symmetry into four subblock partitions (subblocks), including a first vertical rectangular partition corresponding to the left of the current block and having the height of the current block and one-fourth of the width of the current block, a second vertical partition corresponding to the right of the current block and having the height of the current block and one-fourth of the width of the current block, a top partition having half the width of the current block and half of the height of the current block, and a bottom partition having half the width of the current block and half of the height of the current block.

The horizontal-H partition type 830 and the vertical-H partition type 832 are H-partition types.

The available partition types 800 include a first uneven horizontal partition type 840 (HORZ_4A or PARTITION HORZ_4A) wherein the current block is partitioned horizontally with asymmetry into four horizontal rectangular subblock partitions (subblocks), including a first horizontal rectangular partition corresponding to the top of the current block and having the width of the current block and one-eighth of the height of the current block, a second horizontal rectangular partition corresponding to the bottom of the current block and having the width of the current block and one-eighth of the height of the current block, a third horizontal rectangular partition below the first horizontal rectangular partition and having the width of the current block and one-fourth of the height of the current block, and a fourth horizontal rectangular partition below the third horizontal rectangular partition and having the width of the current block and half of the height of the current block.

The available partition types 800 include a second uneven horizontal partition type 842 (HORZ_4B or PARTITION_HORZ_4B) wherein the current block is partitioned horizontally with asymmetry into four horizontal rectangular subblock partitions (subblocks), including a first horizontal rectangular partition corresponding to the top of the current block and having the width of the current block and one-eighth of the height of the current block, a second horizontal rectangular partition corresponding to the bottom of the current block and having the width of the current block and one-eighth of the height of the current block, a third horizontal rectangular partition below the first horizontal rectangular partition and having the width of the current block and half of the height of the current block, and a fourth horizontal rectangular partition below the second horizontal rectangular partition and having the width of the current block and one-fourth of the height of the current block.

The available partition types 800 include a first uneven vertical partition type 844 (VERT_4A or PARTITION_VERT_4A) wherein the current block is partitioned vertically with asymmetry into four vertical rectangular subblock partitions (subblocks), including a first vertical rectangular partition corresponding to the left of the current block and having the height of the current block and one-eighth of the width of the current block, a second vertical rectangular partition corresponding to the right of the current block and having the height of the current block and one-eighth of the width of the current block, a third vertical rectangular partition to the right of the first vertical rectangular partition and having the height of the current block and one-fourth of the width of the current block, and a fourth vertical rectangular partition to the right of the third vertical rectangular partition and having the height of the current block and half of the width of the current block.

The available partition types 800 include a second uneven vertical partition type 846 (VERT_4B or PARTITION_VERT_4B) wherein the current block is partitioned vertically with asymmetry into four vertical rectangular subblock partitions (subblocks), including a first vertical rectangular partition corresponding to the left of the current block and having the height of the current block and one-eighth of the width of the current block, a second vertical rectangular partition corresponding to the right of the current block and having the height of the current block and one-eighth of the width of the current block, a third vertical rectangular partition to the right of the first vertical rectangular partition and having the height of the current block and half of the width of the current block, and a fourth vertical rectangular partition to the right of the third vertical rectangular partition and having the height of the current block and one-fourth of the width of the current block.

The first uneven horizontal partition type 840, the second uneven horizontal partition type 842, the first uneven vertical partition type 844, and the second uneven vertical partition type 846 are uneven 4-way partition types.

For partition types other than the unpartitioned partition type, and for some subblock sizes, such as subblocks larger than a minimum subblock size, such as 4×4, the subblocks may be further partitioned (recursive).

FIG. 9 is a flowchart diagram of an example of obtaining block partition symbols 900. Obtaining block partition symbols 900 may be implemented in an encoder, such as the encoder 400 shown in FIG. 4, or one or more portions thereof, or a decoder, such as the decoder 500 shown in FIG. 5, or one or more portions thereof.

Obtaining block partition symbols 900 includes determining a sequence or series of binary tokens, flags, or symbols (a sequence of block partition symbols), or values thereof, including a split symbol, flag, or token (split), a square-split symbol, flag, or token (square_split), a rectangular-type symbol, flag, or token (rect_type), an extended symbol, flag, or token (ext), a four-way symbol, flag, or token (4way), and an a-or-b symbol, flag, or token (a_or_b). The tokens, flags, or symbols may be derived implicitly or signaled using corresponding context models.

Obtaining block partition symbols 900 includes determining whether the split symbol, flag, or token indicates that the current block is partitioned (SPLIT?) (at 910). The split symbol, flag, or token may have a first value, such as zero (0), indicating that the current block is unpartitioned (NONE at 912) and obtaining block partition symbols 900 may be otherwise omitted, skipped, or excluded for the current block. The split symbol, flag, or token may have a second value, such as one (1), indicating that the current block is partitioned.

Obtaining block partition symbols 900 may include, such as wherein the split symbol, flag, or token indicates that the current block is partitioned, determining whether the square-split symbol, flag, or token indicates that the current block is partitioned using a split partition type, or square-split partition type, such as the split partition type 820 shown in FIG. 8, (SQUARE SPLIT?) (at 920). The square-split symbol, flag, or token may have a first value, such as one (1), indicating that the current block is partitioned using a split partition type (SPLIT at 922) and obtaining block partition symbols 900 may be otherwise omitted, skipped, or excluded for the current block. The square-split symbol, flag, or token may have a second value, such as zero (0), indicating that the current block is partitioned using a partition type other than the split partition type.

Obtaining block partition symbols 900 may include, such as wherein the square-split symbol, flag, or token indicates that the current block is partitioned using a partition type other than the square-split partition type, determining whether the rectangular-type symbol, flag, or token indicates that the current block is partitioned using a horizontal partition type, such as the horizontal partition type 822, the horizontal-H partition type 830, the first uneven horizontal partition type 840, or the second uneven horizontal partition type 842 shown in FIG. 8, or a vertical partition type, such as the vertical partition type 824, the vertical-H partition type 832, the first uneven vertical partition type 844, or the second uneven vertical partition type 846 shown in FIG. 8, (RECT TYPE?) (at 930). The rectangular-type symbol, flag, or token may have a first value, such as zero (0, shown as HORZ in FIG. 9 for clarity), indicating that the current block is partitioned using a horizontal partition type. The square-split symbol, flag, or token may have a second value, such as one (1, shown as VERT in FIG. 9 for clarity), indicating that the current block is partitioned using a vertical partition type.

Obtaining block partition symbols 900 may include, such as wherein the rectangular-type symbol, flag, or token indicates that the current block is partitioned using a horizontal partition type, determining whether the extended symbol, flag, or token indicates that the current block is partitioned using a symmetrical horizontal partition type, such as the horizontal partition type 822 shown in FIG. 8, (EXT?) (at 940). The extended symbol, flag, or token may have a first value, such as zero, indicating that the current block is partitioned using the symmetrical horizontal partition type (HORZ at 942) and obtaining block partition symbols 900 may be otherwise omitted, skipped, or excluded for the current block. The extended symbol, flag, or token may have a second value, such as one, indicating that the current block is partitioned using an asymmetrical horizontal partition type, such as the horizontal-H partition type 830, the first uneven horizontal partition type 840, or the second uneven horizontal partition type 842 shown in FIG. 8.

Obtaining block partition symbols 900 may include, such as wherein the extended symbol, flag, or token indicates that the current block is partitioned using an asymmetrical horizontal partition type, determining whether the four-way symbol, flag, or token indicates that the current block is partitioned using an uneven four-way partition type, such as the first uneven horizontal partition type 840 or the second uneven horizontal partition type 842 shown in FIG. 8, (4WAY?) (at 950). The four-way symbol, flag, or token may have a first value, such as zero (0), indicating that the current block is partitioned using an H-partition type (HORZ_H at 952), such as the horizontal-H partition type 830 shown in FIG. 8, and obtaining block partition symbols 900 may be otherwise omitted, skipped, or excluded for the current block. The four-way symbol, flag, or token may have a second value, such as one (1), indicating that the current block is partitioned using an uneven four-way partition type, such as the first uneven horizontal partition type 840 or the second uneven horizontal partition type 842 shown in FIG. 8.

Obtaining block partition symbols 900 may include, such as wherein the four-way symbol, flag, or token indicates that the current block is partitioned using an uneven four-way partition type, determining whether the a-or-b symbol, flag, or token indicates that the current block is partitioned using the first uneven horizontal partition type, such as the first uneven horizontal partition type 840 shown in FIG. 8, (A OR B?) (at 960). The a-or-b symbol, flag, or token may have a first value, such as zero (0, shown as A in FIG. 9 for clarity), indicating that the current block is partitioned using the first uneven horizontal partition type (HORZ_4A at 962), and obtaining block partition symbols 900 may be otherwise omitted, skipped, or excluded for the current block. The a-or-b symbol, flag, or token may have a second value, such as one (1, shown as B in FIG. 9 for clarity), indicating that the current block is partitioned using the second uneven horizontal partition type, such as the second uneven horizontal partition type 842 shown in FIG. 8, (HORZ_4B at 964), and obtaining block partition symbols 900 may be otherwise omitted, skipped, or excluded for the current block.

Obtaining block partition symbols 900 may include, such as wherein the rectangular-type symbol, flag, or token indicates that the current block is partitioned using a vertical partition type, determining whether the extended symbol, flag, or token indicates that the current block is partitioned using a symmetrical vertical partition type, such as the vertical partition type 824 shown in FIG. 8, (EXT?) (at 970). The extended symbol, flag, or token may have a first value, such as zero (0), indicating that the current block is partitioned using the symmetrical vertical partition type (VERT at 972) and obtaining block partition symbols 900 may be otherwise omitted, skipped, or excluded for the current block. The extended symbol, flag, or token may have a second value, such as one (1), indicating that the current block is partitioned using an asymmetrical vertical partition type, such as the vertical-H partition type 832, the first uneven vertical partition type 844, or the second uneven vertical partition type 846 shown in FIG. 8.

Obtaining block partition symbols 900 may include, such as wherein the extended symbol, flag, or token indicates that the current block is partitioned using an asymmetrical vertical partition type, determining whether the four-way symbol, flag, or token indicates that the current block is partitioned using an uneven four-way partition type, such as the first uneven vertical partition type 844 or the second uneven vertical partition type 846 shown in FIG. 8, (4WAY?) (at 980). The four-way symbol, flag, or token may have a first value, such as zero (0), indicating that the current block is partitioned using an H-partition type (VERT_H at 982), such as the vertical-H partition type 832 shown in FIG. 8, and obtaining block partition symbols 900 may be otherwise omitted, skipped, or excluded for the current block. The four-way symbol, flag, or token may have a second value, such as one (1), indicating that the current block is partitioned using the uneven four-way partition type, such as the first uneven vertical partition type 844 or the second uneven vertical partition type 846 shown in FIG. 8.

Obtaining block partition symbols 900 may include, such as wherein the four-way symbol, flag, or token indicates that the current block is partitioned using an uneven four-way partition type, determining whether the a-or-b symbol, flag, or token indicates that the current block is partitioned using a first uneven vertical partition type, such as the first uneven vertical partition type 844 shown in FIG. 8, (A OR B?) (at 990). The a-or-b symbol, flag, or token may have a first value, such as zero (0, shown as A in FIG. 9 for clarity), indicating that the current block is partitioned using the first uneven vertical partition type (VERT_4A at 992), and obtaining block partition symbols 900 may be otherwise omitted, skipped, or excluded for the current block. The a-or-b symbol, flag, or token may have a second value, such as one (1, shown as B in FIG. 9 for clarity), indicating that the current block is partitioned using a second uneven vertical partition type, such as the second uneven vertical partition type 846 shown in FIG. 8, (VERT_4B at 994), and obtaining block partition symbols 900 may be otherwise omitted, skipped, or excluded for the current block.

FIG. 10 is a block diagram of a first example of block partition context line buffers 1000. FIG. 10 shows the first example of block partition context line buffers 1000 relative to a current block 1010 that is a 16×8 block.

The first example of block partition context line buffers 1000 includes a portion of a vertical context line buffer 1020. Although the vertical context line buffer 1020 is shown as adjacent to the current block 1010 in FIG. 10 for clarity, the current block 1010 in FIG. 10 represents a portion of an image or video frame and the vertical context line buffer 1020 represents a memory buffer with locations corresponding to mode information units.

The vertical context line buffer 1020 includes a first location 1022 corresponding to a first mode information unit. The first location 1022 includes a six-bit code ‘0b111110’ corresponding to a block dimension of eight (8). Prior to coding the current block 1010, the value of the six-bit code included, or stored, in the first location 1022 indicates that a block spatially neighboring the current block 1010, to the left of the current block 1010, has a block height of eight. Subsequent to coding the current block 1010, the value of the six-bit code included, or stored, in the first location 1022 indicates that the current block 1010 has a block height of eight.

The vertical context line buffer 1020 includes a second location 1024 corresponding to a second mode information unit. The second location 1024 includes the six-bit code ‘0b111110’. Prior to coding the current block 1010, the value of the six-bit code included, or stored, in the second location 1024 indicates that the block spatially neighboring the current block 1010, to the left of the current block 1010, has the block height of eight. Subsequent to coding the current block 1010, the value of the six-bit code included, or stored, in the second location 1024 indicates that the current block 1010 has a block height of eight.

Although FIG. 10 shows the values stored in the first location 1022 and the second location 1024 as the six-bit code ‘0b111110’ for simplicity, prior to coding the current block 1010 the values stored in the first location 1022 and the second location 1024 may be other available six-bit codes, as shown in Table 2, indicating that the previously coded block or previously coded blocks neighboring the current block 1010 to the left of the current block 1010 has or have a block height or heights other than eight.

Although FIG. 10 shows a portion of the vertical context line buffer 1020 including two locations corresponding to two mode information units, the vertical context line buffer 1020 may include, for example, sixty-four locations corresponding to sixty-four mode information units, such that the memory utilization for storing the block partition data in the vertical context line buffer 1020 may be 384 bits (64 locations times six bits per location).

The first example of block partition context line buffers 1000 includes a portion of a first example of a horizontal context line buffer 1030.

Although the horizontal context line buffer 1030 is shown as adjacent to the current block 1010 in FIG. 10 for clarity, the current block 1010 in FIG. 10 represents a portion of an image or video frame and the horizontal context line buffer 1030 represents a memory buffer with locations corresponding to mode information units.

The horizontal context line buffer 1030 includes a third location 1032 corresponding to a third mode information unit. The third location 1032 includes a six-bit code ‘0b111100’ corresponding to a block dimension of sixteen (16). Prior to coding the current block 1010, the value of the six-bit code included, or stored, in the third location 1032 indicates that a block spatially neighboring the current block 1010, above the current block 1010, has a block width of sixteen. Subsequent to coding the current block 1010, the value of the six-bit code included, or stored, in the third location 1032 indicates that the current block 1010 has the block width of sixteen.

The horizontal context line buffer 1030 includes a fourth location 1034 corresponding to a fourth mode information unit. The fourth location 1034 includes the six-bit code ‘0b111100’. Prior to coding the current block 1010, the value of the six-bit code included, or stored, in the fourth location 1034 indicates that the block spatially neighboring the current block 1010, above the current block 1010, has the block width of sixteen. Subsequent to coding the current block 1010, the value of the six-bit code included, or stored, in the fourth location 1034 indicates that the current block 1010 has the block width of sixteen.

The horizontal context line buffer 1030 includes a fifth location 1036 corresponding to a fifth mode information unit. The fifth location 1036 includes the six-bit code ‘0b111100’. Prior to coding the current block 1010, the value of the six-bit code included, or stored, in the fifth location 1036 indicates that the block spatially neighboring the current block 1010, above the current block 1010, has the block width of sixteen. Subsequent to coding the current block 1010, the value of the six-bit code included, or stored, in the fifth location 1036 indicates that the current block 1010 has the block width of sixteen.

The horizontal context line buffer 1030 includes a sixth location 1038 corresponding to a sixth mode information unit. The sixth location 1038 includes the six-bit code ‘0b111100’. Prior to coding the current block 1010, the value of the six-bit code included, or stored, in the sixth location 1038 indicates that the block spatially neighboring the current block 1010, above the current block 1010, has the block width of sixteen. Subsequent to coding the current block 1010, the value of the six-bit code included, or stored, in the sixth location 1038 indicates that the current block 1010 has the block width of sixteen.

Although FIG. 10 shows the values stored in the third location 1032, the fourth location 1034, the fifth location 1036, and the sixth location 1038 as the six-bit code ‘0b111100’ for simplicity, prior to coding the current block 1010 the values stored in the third location 1032, the fourth location 1034, the fifth location 1036, and the sixth location 1038 may be other available six-bit codes, as shown in Table 2, indicating that the previously coded block or previously coded blocks neighboring the current block 1010 above the current block 1010 has or have a block width or widths other than sixteen.

Although FIG. 10 shows a portion of the horizontal context line buffer 1030 including four locations corresponding to four mode information units, the horizontal context line buffer 1030 may include, for example, another number, count, or cardinality of locations corresponding to a number, count, or cardinality of mode information units corresponding to a tile width of a current tile that includes the current block 1010, such that the memory utilization for storing the block partition data in the horizontal context line buffer 1030 may be six times the number, count, or cardinality of mode information units in a row of the current tile.

FIG. 11 is a block diagram of a second example of block partition context line buffers 1100. FIG. 11 shows the second example of block partition context line buffers 1100 relative to a partitioned block 1110.

The second example of block partition context line buffers 1100 includes a portion of a vertical context line buffer 1120. Although the vertical context line buffer 1120 is shown to the right of the partitioned block 1110 in FIG. 11 for clarity, the partitioned block 1110 in FIG. 11 represents a portion of an image or video frame and the vertical context line buffer 1120 represents a memory buffer with locations corresponding to mode information units.

The vertical context line buffer 1120 includes a first location 1121 corresponding to a first mode information unit. The first location 1121 includes a bit, or flag, having a value of one indicating that a top boundary of the mode information unit corresponding to the first location 1121 is aligned with a horizontal block boundary in the partitioned block 1110.

The vertical context line buffer 1120 includes a second location 1122 corresponding to a second mode information unit. The second location 1122 includes a bit, or flag, having a value of zero indicating that a top boundary of the mode information unit corresponding to the second location 1122 is unaligned with a horizontal block boundary in the partitioned block 1110.

The vertical context line buffer 1120 includes a third location 1123 corresponding to a third mode information unit. The third location 1123 includes a bit, or flag, having a value of zero indicating that a top boundary of the mode information unit corresponding to the third location 1123 is unaligned with a horizontal block boundary in the partitioned block 1110.

The vertical context line buffer 1120 includes a fourth location 1124 corresponding to a fourth mode information unit. The fourth location 1124 includes a bit, or flag, having a value of zero indicating that a top boundary of the mode information unit corresponding to the fourth location 1124 is unaligned with a horizontal block boundary in the partitioned block 1110.

The vertical context line buffer 1120 includes a fifth location 1125 corresponding to a fifth mode information unit. The fifth location 1125 includes a bit, or flag, having a value of one indicating that a top boundary of the mode information unit corresponding to the fifth location 1125 is aligned with a horizontal block boundary in the partitioned block 1110.

The vertical context line buffer 1120 includes a sixth location 1126 corresponding to a sixth mode information unit. The sixth location 1126 includes a bit, or flag, having a value of one indicating that a top boundary of the mode information unit corresponding to the sixth location 1126 is aligned with a horizontal block boundary in the partitioned block 1110.

The vertical context line buffer 1120 includes a seventh location 1127 corresponding to a seventh mode information unit. The seventh location 1127 includes a bit, or flag, having a value of one indicating that a top boundary of the mode information unit corresponding to the seventh location 1127 is aligned with a horizontal block boundary in the partitioned block 1110.

The vertical context line buffer 1120 includes an eighth location 1128 corresponding to an eighth mode information unit. The eighth location 1128 includes a bit, or flag, having a value of one indicating that a top boundary of the mode information unit corresponding to the eighth location 1128 is aligned with a horizontal block boundary in the partitioned block 1110.

Although FIG. 11 shows a portion of the vertical context line buffer 1120 including eight locations corresponding to eight mode information units, the vertical context line buffer 1120 may include, for example, sixty-four locations corresponding to sixty-four mode information units, such that the memory utilization for storing the block partition data in the vertical context line buffer 1120 may be 64 bits (64 locations times one bit per location).

The second example of block partition context line buffers 1100 includes a portion of a horizontal context line buffer 1130. Although the horizontal context line buffer 1130 is shown as adjacent to the partitioned block 1110 in FIG. 11 for clarity, the partitioned block 1110 in FIG. 11 represents a portion of an image or video frame and the horizontal context line buffer 1130 represents a memory buffer with locations corresponding to mode information units.

The horizontal context line buffer 1130 includes a ninth location 1131 corresponding to a ninth mode information unit. The ninth location 1131 includes a bit, or flag, having a value of one indicating that a left boundary of the mode information unit corresponding to the ninth location 1131 is aligned with a vertical block boundary in the partitioned block 1110.

The horizontal context line buffer 1130 includes a tenth location 1132 corresponding to a tenth mode information unit. The tenth location 1132 includes a bit, or flag, having a value of zero indicating that a left boundary of the mode information unit corresponding to the tenth location 1132 is unaligned with a vertical block boundary in the partitioned block 1110.

The horizontal context line buffer 1130 includes an eleventh location 1133 corresponding to an eleventh mode information unit. The eleventh location 1133 includes a bit, or flag, having a value of zero indicating that a left boundary of the mode information unit corresponding to the eleventh location 1133 is unaligned with a vertical block boundary in the partitioned block 1110.

The horizontal context line buffer 1130 includes a twelfth location 1134 corresponding to a twelfth mode information unit. The twelfth location 1134 includes a bit, or flag, having a value of zero indicating that a left boundary of the mode information unit corresponding to the twelfth location 1134 is unaligned with a vertical block boundary in the partitioned block 1110.

The horizontal context line buffer 1130 includes a thirteenth location 1135 corresponding to a thirteenth mode information unit. The thirteenth location 1135 includes a bit, or flag, having a value of one indicating that a left boundary of the mode information unit corresponding to the thirteenth location 1135 is aligned with a vertical block boundary in the partitioned block 1110.

The horizontal context line buffer 1130 includes a fourteenth location 1136 corresponding to a fourteenth mode information unit. The fourteenth location 1136 includes a bit, or flag, having a value of zero indicating that a left boundary of the mode information unit corresponding to the fourteenth location 1136 is unaligned with a vertical block boundary in the partitioned block 1110.

The horizontal context line buffer 1130 includes a fifteenth location 1137 corresponding to a fifteenth mode information unit. The fifteenth location 1137 includes a bit, or flag, having a value of one indicating that a left boundary of the mode information unit corresponding to the fifteenth location 1137 is aligned with a vertical block boundary in the partitioned block 1110.

The horizontal context line buffer 1130 includes a sixteenth location 1138 corresponding to a sixteenth mode information unit. The sixteenth location 1138 includes a bit, or flag, having a value of one indicating that a left boundary of the mode information unit corresponding to the sixteenth location 1138 is aligned with a vertical block boundary in the partitioned block 1110.

Although FIG. 11 shows a portion of the horizontal context line buffer 1130 including eight locations corresponding to eight mode information units, the horizontal context line buffer 1130 may include, for example, another number, count, or cardinality of locations corresponding to a number, count, or cardinality of mode information units corresponding to a tile width of a current tile that includes the partitioned block 1110, such that the memory utilization for storing the block partition data in the horizontal context line buffer 1130 may be the number, count, or cardinality of mode information units in a row of the current tile.

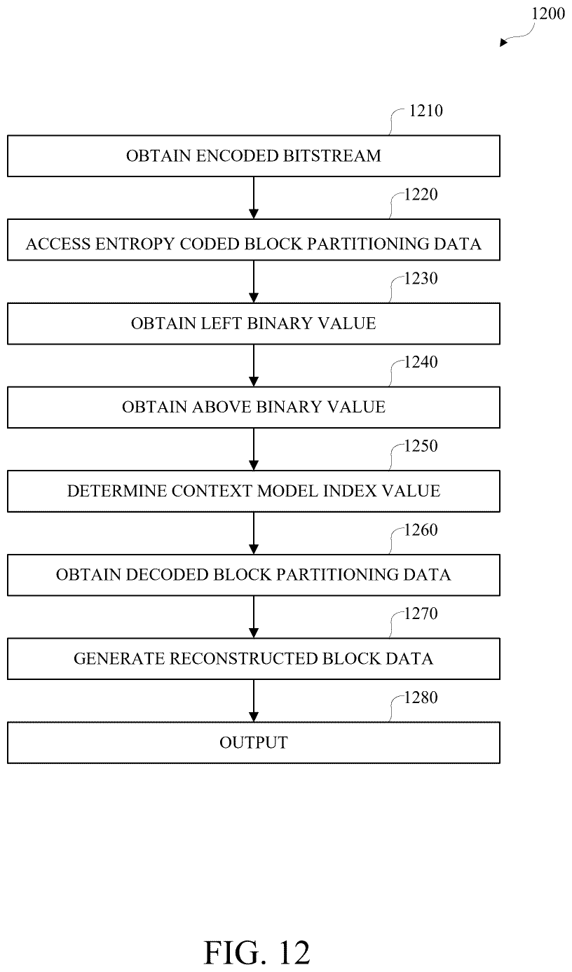

FIG. 12 is a flowchart diagram of an example of decoding using partition symbol context models 1200 in accordance with implementations of this disclosure. Decoding using partition symbol context models 1200 may be implemented in a decoder, such as the decoder 500 shown in FIG. 5.

Decoding using partition symbol context models 1200 includes obtaining reconstructed block data for a current block of a current frame of a sequence of frames by decoding an encoded bitstream, such as the compressed bitstream 502 shown in FIG. 5, or one or more portions thereof, to generate a reconstructed video, or a portion thereof, such as the output video stream 504 shown in FIG. 5.

Decoding using partition symbol context models 1200 includes obtaining the encoded bitstream (at 1210), accessing entropy coded block partition data (at 1220), obtaining a left binary value (at 1230), obtaining an above binary value (at 1240), determining a context model index value (at 1250), obtaining decoded block partition data (at 1260), generating reconstructed block data (at 1270), and outputting the reconstructed data (at 1280).

The encoded bitstream is obtained (at 1210). Obtaining the encoded bitstream includes identifying a current frame to decode from the encoded bitstream to generate a current reconstructed frame, which includes identifying a current block from the current frame to decode from the encoded bitstream to generate a current reconstructed block to include in the current reconstructed frame. For example, the decoder, or a component thereof, such as an intra/inter prediction unit of the decoder, such as the entropy decoding unit 510 shown in FIG. 5, may obtain the input video stream. The current frame may be obtained (at 1210) subsequent to decoding one or more other frames, such as a frame sequentially preceding the current frame, and generating, or otherwise obtaining, a corresponding reconstructed frame (or frames), or one or more portions thereof, for use as a reference frame (or frames) for decoding the current frame. Although not shown separately in FIG. 12, decoding using partition symbol context models 1200 may include decoding, reconstructing, or both, one or more portions of the current frame prior to decoding, reconstructing, or both, the current block.

Accessing entropy coded block partition data (at 1220) includes reading the entropy coded block partition data from the encoded bitstream.

Obtaining the left binary value (at 1230) is similar to obtaining a left binary value as shown (at 730) in FIG. 7, except as is described herein or as is otherwise clear from context.

Obtaining the above binary value (at 1240) is similar to obtaining an above binary value as shown (at 740) in FIG. 7, except as is described herein or as is otherwise clear from context.

Determining the context model index value (at 1250) is similar to determining a context model index value as shown (at 750) in FIG. 7, except as is described herein or as is otherwise clear from context.

Obtaining decoded block partition data (at 1260) includes obtaining the decoded block partition data for the current block by entropy decoding the entropy coded block partition data in accordance with an entropy coding context model indicated by the context model index value.

Generating reconstructed block data (at 1270) includes generating the reconstructed block data in accordance with the decoded block partition data.

Generating the reconstructed block data may include aspects not expressly shown in FIG. 12 for simplicity, such as filtering, such as the filtering shown (at 560) in FIG. 5.

Outputting the reconstructed data (at 1280) includes including the reconstructed block data in reconstructed frame data for the current frame and outputting the reconstructed frame data.

Although not expressly shown in FIG. 12, in some implementations obtaining the reconstructed block data may include, subsequent to determining that the decoded block partition data indicates that the current block is an unpartitioned block, storing a binary value of one in a location in the vertical line buffer corresponding to the top-left mode information unit, on a condition that a height of the current block in mode information units is greater than one, storing binary values of zero in locations in the vertical line buffer corresponding to mode information units of the current block other than the top-left mode information unit, and on a condition that a width of the current block in mode information units is greater than one, storing binary values of zero in locations in the horizontal line buffer corresponding to mode information units of the current block other than the top-left mode information unit.

As used herein, the terms “optimal”, “optimized”, “optimization”, or other forms thereof, are relative to a respective context and are not indicative of absolute theoretic optimization unless expressly specified herein.

As used herein, the term “set” indicates a distinguishable collection or grouping of zero or more distinct elements or members that may be represented as a one-dimensional array or vector, except as expressly described herein or otherwise clear from context.

The words “example” or “exemplary” are used herein to mean serving as an example, instance, or illustration. Any aspect or design described herein as “example” or “exemplary” not necessarily to be construed as preferred or advantageous over other aspects or designs. Rather, use of the words “example” or “exemplary” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an embodiment” or “one embodiment” or “an implementation” or “one implementation” throughout is not intended to mean the same embodiment or implementation unless described as such. As used herein, the terms “determine” and “identify”, or any variations thereof, includes selecting, ascertaining, computing, looking up, receiving, determining, establishing, obtaining, or otherwise identifying or determining in any manner whatsoever using one or more of the devices shown in FIG. 1.

Further, for simplicity of explanation, although the figures and descriptions herein may include sequences or series of steps or stages, elements of the methods disclosed herein can occur in various orders and/or concurrently. Additionally, elements of the methods disclosed herein may occur with other elements not explicitly presented and described herein. Furthermore, one or more elements of the methods described herein may be omitted, avoided, or excluded from implementations of methods in accordance with the disclosed subject matter.

The implementations of the transmitting computing and communication device 100A and/or the receiving computing and communication device 100B (and the algorithms, methods, instructions, etc. stored thereon and/or executed thereby) can be realized in hardware, software, or any combination thereof. The hardware can include, for example, computers, intellectual property (IP) cores, application-specific integrated circuits (ASICs), programmable logic arrays, optical processors, programmable logic controllers, microcode, microcontrollers, servers, microprocessors, digital signal processors or any other suitable circuit. In the claims, the term “processor” should be understood as encompassing any of the foregoing hardware, either singly or in combination. The terms “signal” and “data” are used interchangeably. Further, portions of the transmitting computing and communication device 100A and the receiving computing and communication device 100B do not necessarily have to be implemented in the same manner.

Further, in one implementation, for example, the transmitting computing and communication device 100A or the receiving computing and communication device 100B can be implemented using a computer program that, when executed, carries out any of the respective methods, algorithms and/or instructions described herein. In addition, or alternatively, for example, a special purpose computer/processor can be utilized which can contain specialized hardware for carrying out any of the methods, algorithms, or instructions described herein.

The transmitting computing and communication device 100A and receiving computing and communication device 100B can, for example, be implemented on computers in a real-time video system. Alternatively, the transmitting computing and communication device 100A can be implemented on a server and the receiving computing and communication device 100B can be implemented on a device separate from the server, such as a hand-held communications device. In this instance, the transmitting computing and communication device 100A can encode content using an encoder 400 into an encoded video signal and transmit the encoded video signal to the communications device. In turn, the communications device can then decode the encoded video signal using a decoder 500. Alternatively, the communications device can decode content stored locally on the communications device, for example, content that was not transmitted by the transmitting computing and communication device 100A. Other suitable transmitting computing and communication device 100A and receiving computing and communication device 100B implementation schemes are available. For example, the receiving computing and communication device 100B can be a generally stationary personal computer rather than a portable communications device and/or a device including an encoder 400 may also include a decoder 500.

Further, all or a portion of implementations can take the form of a computer program product accessible from, for example, a tangible computer-usable or computer-readable medium. A computer-usable or computer-readable medium can be any device that can, for example, tangibly contain, store, communicate, or transport the program for use by or in connection with any processor. The medium can be, for example, an electronic, magnetic, optical, electromagnetic, or a semiconductor device. Other suitable mediums are also available.

It will be appreciated that aspects can be implemented in any convenient form. For example, aspects may be implemented by appropriate computer programs which may be carried on appropriate carrier media which may be tangible carrier media (e.g. disks) or intangible carrier media (e.g. communications signals). Aspects may also be implemented using suitable apparatus which may take the form of programmable computers running computer programs arranged to implement the methods and/or techniques disclosed herein. Aspects can be combined such that features described in the context of one aspect may be implemented in another aspect.

The above-described implementations have been described in order to allow easy understanding of the application and are not limiting. On the contrary, the application covers various modifications and equivalent arrangements included within the scope of the appended claims, which scope is to be accorded the broadest interpretation so as to encompass all such modifications and equivalent structure as is permitted under the law.

What is claimed is:

1. A method comprising:
obtaining reconstructed block data for a current block of a current frame of a sequence of frames, wherein obtaining the reconstructed block data includes:
accessing, from an encoded bitstream, entropy coded block partition data for the current block;
obtaining a left binary value indicating whether a location in a vertical line buffer for entropy coding context data for block partition signaling, in a range of locations in the vertical line buffer from a first location in the vertical line buffer corresponding to a first mode information unit start value to a second location in the vertical line buffer corresponding to a first mode information unit end value, indicates a block partition boundary;
obtaining an above binary value indicating whether a location in a horizontal line buffer for entropy coding context data for block partition signaling, in a range of locations in the horizontal line buffer from a first location in the horizontal line buffer corresponding to a second mode information unit start value to a second location in the horizontal line buffer corresponding to a second mode information unit end value, indicates a block partition boundary;
determining a context model index value in accordance with the left binary value and the above binary value;
obtaining decoded block partition data for the current block by entropy decoding the entropy coded block partition data in accordance with an entropy coding context model indicated by the context model index value; and
generating the reconstructed block data in accordance with the decoded block partition data;
including the reconstructed block data in reconstructed frame data for the current frame; and
outputting the reconstructed frame data.

2. The method of claim 1, wherein:
the first mode information unit start value is a sum of a mode information unit row index value for a top-left mode information unit of the current block and one; and
the first mode information unit end value is a sum of the first mode information unit start value and a first mode information unit length value, wherein the first mode information unit length value is a result of subtracting one from a height of the current block in mode information units.

3. The method of claim 1, wherein:
the second mode information unit start value is a sum of a mode information unit column index value for a top-left mode information unit of the current block and one; and
the second mode information unit end value is a sum of the second mode information unit start value and a second mode information unit length value, wherein the second mode information unit length value is a result of subtracting one from a width of the current block in mode information units.

4. The method of claim 1, wherein determining the context model index value includes obtaining, as the context model index value, a sum of a product of multiplying a block size group index value for the current block by four, a product of multiplying the left binary value by two, and the above binary value.

5. The method of claim 1, wherein:
obtaining the left binary value includes obtaining, as the left binary value, a result of a bit masking AND operation with respect to bits stored in the range of locations in the vertical line buffer, wherein a respective location from the range of locations in the vertical line buffer stores one bit; and
obtaining the above binary value includes obtaining, as the above binary value, a result of a bit masking AND operation with respect to bits stored in the range of locations in the horizontal line buffer, wherein a respective location from the range of locations in the horizontal line buffer stores one bit.

6. The method of claim 1, wherein:
obtaining the left binary value includes obtaining one as the left binary value in response to a determination that at least one location in the range of locations in the vertical line buffer stores a value of one;
obtaining the above binary value includes obtaining one as the above binary value in response to a determination that at least one location in the range of locations in the horizontal line buffer stores a value of one;
obtaining the left binary value includes obtaining zero as the left binary value in response to a determination that bits stored in the range of locations in the vertical line buffer having a value of one are absent; and
obtaining the above binary value includes obtaining zero as the above binary value in response to a determination that bits stored in the range of locations in the horizontal line buffer having a value of one are absent.

7. The method of claim 1, wherein obtaining the reconstructed block data includes:
subsequent to determining that the decoded block partition data indicates that the current block is an unpartitioned block:
storing a binary value of one in a location in the vertical line buffer corresponding to a top-left mode information unit of the current block;
storing a binary value of one in a location in the horizontal line buffer corresponding to the top-left mode information unit;
on a condition that a height of the current block in mode information units is greater than one, storing binary values of zero in locations in the vertical line buffer corresponding to mode information units of the current block other than the top-left mode information unit; and
on a condition that a width of the current block in mode information units is greater than one, storing binary values of zero in locations in the horizontal line buffer corresponding to mode information units of the current block other than the top-left mode information unit.

8. An apparatus comprising:
a non-transitory computer-readable medium; and
a processor configured to execute instructions stored on the non-transitory computer-readable medium to:
obtain reconstructed block data for a current block of a current frame of a sequence of frames, wherein to obtain the reconstructed block data, the processor is configured to execute the instructions to:
access, from an encoded bitstream, entropy coded block partition data for the current block;
obtain a left binary value indicating whether a location in a vertical line buffer for entropy coding context data for block partition signaling, in a range of locations in the vertical line buffer from a first location in the vertical line buffer corresponding to a first mode information unit start value to a second location in the vertical line buffer corresponding to a first mode information unit end value, indicates a block partition boundary;
obtain an above binary value indicating whether a location in a horizontal line buffer for entropy coding context data for block partition signaling, in a range of locations in the horizontal line buffer from a first location in the horizontal line buffer corresponding to a second mode information unit start value to a second location in the horizontal line buffer corresponding to a second mode information unit end value, indicates a block partition boundary;
determine a context model index value in accordance with the left binary value and the above binary value;
obtain decoded block partition data for the current block by entropy decoding the entropy coded block partition data in accordance with an entropy coding context model indicated by the context model index value; and
generate the reconstructed block data in accordance with the decoded block partition data;
include the reconstructed block data in reconstructed frame data for the current frame; and
output the reconstructed frame data.

9. The apparatus of claim 8, wherein:
the first mode information unit start value is a sum of a mode information unit row index value for a top-left mode information unit of the current block and one; and
the first mode information unit end value is a sum of the first mode information unit start value and a first mode information unit length value, wherein the first mode information unit length value is a result of subtracting one from a height of the current block in mode information units.

10. The apparatus of claim 8, wherein:
the second mode information unit start value is a sum of a mode information unit column index value for a top-left mode information unit of the current block and one; and
the second mode information unit end value is a sum of the second mode information unit start value and a second mode information unit length value, wherein the second mode information unit length value is a result of subtracting one from a width of the current block in mode information units.

11. The apparatus of claim 8, wherein to determine the context model index value, the processor is configured to execute the instructions to obtain, as the context model index value, a sum of a product of multiplication of a block size group index value for the current block by four, a product of multiplication of the left binary value by two, and the above binary value.

12. The apparatus of claim 8, wherein:
to obtain the left binary value, the processor is configured to execute the instructions to obtain, as the left binary value, a result of a bit masking AND operation with respect to bits stored in the range of locations in the vertical line buffer, wherein a respective location from the range of locations in the vertical line buffer stores one bit; and
to obtain the above binary value, the processor is configured to execute the instructions to obtain, as the above binary value, a result of a bit masking AND operation with respect to bits stored in the range of locations in the horizontal line buffer, wherein a respective location from the range of locations in the horizontal line buffer stores one bit.

13. The apparatus of claim 8, wherein:
to obtain the left binary value, the processor is configured to execute the instructions to obtain one as the left binary value in response to a determination that at least one location in the range of locations in the vertical line buffer stores a value of one;
to obtain the above binary value, the processor is configured to execute the instructions to obtain one as the above binary value in response to a determination that at least one location in the range of locations in the horizontal line buffer stores a value of one;
to obtain the left binary value, the processor is configured to execute the instructions to obtain zero as the left binary value in response to a determination that bits stored in the range of locations in the vertical line buffer having a value of one are absent; and
to obtain the above binary value, the processor is configured to execute the instructions to obtain zero as the above binary value in response to a determination that bits stored in the range of locations in the horizontal line buffer having a value of one are absent.

14. The apparatus of claim 8, wherein to obtain the reconstructed block data, the processor is configured to execute the instructions to:
subsequent to a determination that the decoded block partition data indicates that the current block is an unpartitioned block:
store a binary value of one in a location in the vertical line buffer corresponding to a top-left mode information unit of the current block;
store a binary value of one in a location in the horizontal line buffer corresponding to the top-left mode information unit;
on a condition that a height of the current block in mode information units is greater than one, store binary values of zero in locations in the vertical line buffer corresponding to mode information units of the current block other than the top-left mode information unit; and
on a condition that a width of the current block in mode information units is greater than one, store binary values of zero in locations in the horizontal line buffer corresponding to mode information units of the current block other than the top-left mode information unit.

15. A method comprising:
generating an encoded bitstream by encoding a current block from a current frame from an input video, wherein encoding the current block includes:
obtaining block partition data for the current block;
obtaining a left binary value indicating whether a location in a vertical line buffer for entropy coding context data for block partition signaling, in a range of locations in the vertical line buffer from a first location in the vertical line buffer corresponding to a first mode information unit start value to a second location in the vertical line buffer corresponding to a first mode information unit end value, indicates a block partition boundary;
obtaining an above binary value indicating whether a location in a horizontal line buffer for entropy coding context data for block partition signaling, in a range of locations in the horizontal line buffer from a first location in the horizontal line buffer corresponding to a second mode information unit start value to a second location in the horizontal line buffer corresponding to a second mode information unit end value, indicates a block partition boundary;
determining a context model index value in accordance with the left binary value and the above binary value;
obtaining entropy coded block partition data for the current block by entropy coding the block partition data in accordance with an entropy coding context model indicated by the context model index value; and
including the entropy coded block partition data in the encoded bitstream; and
outputting the encoded bitstream.

16. The method of claim 15, wherein:
the first mode information unit start value is a sum of a mode information unit row index value for a top-left mode information unit of the current block and one;
the first mode information unit end value is a sum of the first mode information unit start value and a first mode information unit length value, wherein the first mode information unit length value is a result of subtracting one from a height of the current block in mode information units;
the second mode information unit start value is a sum of a mode information unit column index value for the top-left mode information unit of the current block and one; and
the second mode information unit end value is a sum of the second mode information unit start value and a second mode information unit length value, wherein the second mode information unit length value is a result of subtracting one from a width of the current block in mode information units.

17. The method of claim 15, wherein determining the context model index value includes obtaining, as the context model index value, a sum of a product of multiplying a block size group index value for the current block by four, a product of multiplying the left binary value by two, and the above binary value.

18. The method of claim 15, wherein:
obtaining the left binary value includes obtaining, as the left binary value, a result of a bit masking AND operation with respect to bits stored in the range of locations in the vertical line buffer, wherein a respective location from the range of locations in the vertical line buffer stores one bit; and
obtaining the above binary value includes obtaining, as the above binary value, a result of a bit masking AND operation with respect to bits stored in the range of locations in the horizontal line buffer, wherein a respective location from the range of locations in the horizontal line buffer stores one bit.

19. The method of claim 15, wherein:
obtaining the left binary value includes obtaining one as the left binary value in response to a determination that at least one bit stored in the range of locations in the vertical line buffer has a value of one;
obtaining the above binary value includes obtaining one as the above binary value in response to a determination that at least one bit stored in the range of locations in the horizontal line buffer has a value of one;
obtaining the left binary value includes obtaining zero as the left binary value in response to a determination that bits stored in the range of locations in the vertical line buffer having a value of one are absent; and
obtaining the above binary value includes obtaining zero as the above binary value in response to a determination that bits stored in the range of locations in the horizontal line buffer having a value of one are absent.

20. The method of claim 15, wherein encoding the current block includes:
subsequent to determining the context model index value:
storing a binary value of one in a location in the vertical line buffer corresponding to a top-left mode information unit of the current block;
storing a binary value of one in a location in the horizontal line buffer corresponding to the top-left mode information unit;
on a condition that a height of the current block in mode information units is greater than one, storing binary values of zero in locations in the vertical line buffer corresponding to mode information units of the current block other than the top-left mode information unit; and
on a condition that a width of the current block in mode information units is greater than one, storing binary values of zero in locations in the horizontal line buffer corresponding to mode information units of the current block other than the top-left mode information unit.
